(19) United States
(12) Patent Application Publication
(10) Pub. No.: US 2023/0324336 A1
(43) Pub. Date: Oct. 12, 2023

(54) Disambiguation of cyclic ion analyser spectra

(71) Applicant: Thermo Fisher Scientific (Bremen) GmbH, Bremen (DE)

(72) Inventors: Hamish Stewart, Bremen (DE); Dmitry Grinfeld, Bremen (DE); Bernd Hagedorn, Bremen (DE); Robert Ostermann, Bremen (DE)

(21) Appl. No.: 18/118,456

(22) Filed: Mar. 7, 2023

(30) Foreign Application Priority Data
Mar. 8, 2022 (GB) GB2203184.3

(51) Int. Cl. G01N 27/623; H01J 49/40

(52) U.S. Cl. CPC G01N 27/623; H01J 49/40

(57) ABSTRACT

Embodiments provide methods of disambiguating the spectra produced by cyclic ion analysers. Systems, methods, and computer readable media described herein can compare two sets of ion data that have been obtained using different analyser settings such that the number of passes N through the cyclic segment of the ion path taken by ions contributing to an ion peak can be determined. As a result of the determination of the number of passes N taken by ions, the physicochemical property of those ions can be unambiguously assigned to the ion peak.

### FIELD OF THE INVENTION

The present invention relates to methods of analysing ions, and in particular to time-of-flight (ToF) mass analysers and to ion mobility analysers.

### BACKGROUND

In time-of-flight (ToF) analysers and ion mobility analysers, ions are passed through a drift region of the analyser and are eventually detected by a detector. A physicochemical property of an ion, such as its mass to charge ratio (m/z) or ion mobility, is determined from the ion's drift time through the drift region.

It can often be desirable to increase the resolution of an analyser, both for improved separation of analyte ions and for accurate determination of their physicochemical properties such as mass. An instrument's resolution is limited by (amongst other things) the total length of the ion flight path through the analyser.

Several “cyclic” analysis techniques exist, whereby ions are made to make plural repeated cycles along an ion path within the analyser. Increasing the number of cycles N increases the length of the ion flight path that ions take within the analyser, thereby increasing the resolution of the analyser.

However, during multiple cycles N through the analyser, lighter faster moving ions can overtake (e.g., lap) heavier slower moving ions. This complicates the resulting spectra and can make it difficult to accurately determine the physicochemical property of all of the detected ions.

It is believed that there remains scope for improvements to methods of operating ion analysers.

### SUMMARY

A first aspect provides a method of operating an analytical instrument that comprises an ion analyser configured to analyse ions by determining drift times of ions along an ion path, the ion path comprising at least a first segment, and a cyclic segment, wherein the ion path is configured such that ions make a single pass of the first segment and make one or more passes of the cyclic segment; the method comprising:
operating the analyser in a first mode of operation, wherein in the first mode of operation (i) a first electric potential is provided along the first segment of the ion path, (ii) a second electric potential is provided along the cyclic segment of the ion path, (iii) the first segment of the ion path has a first path length, and (iv) the cyclic segment of the ion path has a second path length, and analysing ions by determining drift times of ions along the ion path so as to obtain a first set of ion data;
operating the analyser in a second mode of operation by altering at least one of (i) the first electric potential, (ii) the second electric potential, (iii) the first path length, and (iv) the second path length, and analysing ions by determining drift times of ions along the ion path so as to obtain a second set of ion data;
comparing the first set of ion data to the second set of ion data, and identifying a first ion peak in the first set of ion data that corresponds to a second ion peak in the second set of ion data;
determining the number N of passes of the cyclic segment of the ion path taken by ions associated with the corresponding first and second ion peaks; and
using the determined number of passes N to determine a physicochemical property of the ions associated with the corresponding first and second ion peaks.

Embodiments relate to methods of operating a cyclic ion analyser. The analyser is configured to analyse ions by determining (e.g., measuring) the drift times of the ions along an ion path, where the ions can make multiple passes through a cyclic segment of the ion path before being detected. In cyclic analysers, ions that have very different physicochemical properties (e.g., mass to charge ratio (m/z) or ion mobility) can have similar drift times through the analyser, e.g., due to faster moving ions overtaking (e.g., lapping) slower moving ions in the cyclic segment of the ion path. This can complicate the resulting spectra and can make it difficult to accurately determine physicochemical properties of the detected ions.

Embodiments provide methods of disambiguating the spectra produced by cyclic ion analysers. As will be described in more detail below, by comparing two sets of ion data that have been obtained using different analyser settings, the number of passes N through the cyclic segment of the ion path taken by ions contributing to an ion peak can be determined, thereby allowing the physicochemical property of those ions to be unambiguously assigned to the ion peak.

The analytical instrument may be a mass spectrometer, an ion mobility spectrometer, or a combination of the two (e.g., a mass spectrometer which includes an ion mobility separator). The instrument may comprise an ion source. Ions may be generated from a sample in the ion source. The ions may be passed from the ion source to the analyser via one or more ion optical devices arranged between the ion source and the analyser.

The one or more ion optical devices may comprise any suitable arrangement of one or more ion guides, one or more lenses, one or more gates, and the like. The one or more ion optical devices may include one or more transfer ions guides for transferring ions, and/or one or more mass selector or filters for mass selecting ions, and/or one or more ion cooling ion guides for cooling ions, and/or one or more collision or reaction cells for fragmenting or reacting ions, and so on. One or more of each ion guide may comprise a multipole ion guide such as a quadrupole ion guide, hexapole ion guide, etc., a segmented multipole ion guide, a stacked ring type ion guide, and the like.

The ion analyser is configured to analyse ions by determining drift times of ions along an ion path. Thus, the ion analyser may comprise an ion injector arranged at the start of the ion path, and an ion detector arranged at the end of the ion path. The ion injector may be configured to receive ions from the ion source via the one or more ion optical devices. The ion injector may be configured to inject (received) ions into the ion path (e.g., by accelerating ions along the ion path), whereupon ions travel along the ion path to the detector. The ion injector can be in any suitable form, such as for example an ion trap, or one or more (e.g., orthogonal) acceleration electrodes. Upon reaching the detector, the ions may be detected by the detector, and e.g., their arrival time may be recorded by the detector. A physicochemical property of the ions, such as their mass to charge ratio and/or ion mobility, may then be determined from the measured drift time.

The ion analyser is a cyclic analyser. Thus, the ion path includes a cyclic segment, wherein ions can make plural (repeated) passes of the cyclic segment when travelling along the ion path (from the ion injector to the detector). The ion path also includes at least one first (non-cyclic) segment, wherein ions make only a single pass of the first segment when travelling along the ion path (from the ion injector to the detector). The first segment may be directly adjacent to (i.e., may directly adjoin) the cyclic segment of the ion path. The first segment may be upstream of or downstream of the cyclic segment.

The ion path may optionally comprise a second (non-cyclic) segment, wherein ions make only a single pass of the second segment when travelling along the ion path (from the ion injector to the detector). The second segment may be directly adjacent to (i.e., may directly adjoin) the cyclic segment of the ion path. The second segment may be upstream of or downstream of the cyclic segment, e.g., such that the ion path comprises a first (non-cyclic) segment, a cyclic segment arranged downstream of the first segment, and a second (non-cyclic) segment arranged downstream of the cyclic segment.

Thus, when travelling along the ion path (from the ion injector to the detector), ions may make a single pass of the first segment, followed by one or more (e.g., plural) passes of the cyclic segment, optionally followed by a single pass of the second segment, before being detected by the detector.

The ion analyser may be a time-of-flight (ToF) mass analyser configured to determine the mass to charge ratio (m/z) of ions from their drift times, or an ion mobility analyser configured to determine the ion mobility of ions from their drift times.

In embodiments, the analyser is a closed-loop multi-reflection ion trap mass analyser. Thus, the analyser may comprise two ion mirrors spaced apart and opposing each other in a first direction X, an ion injector for injecting ions into a space between the ion mirrors, and a detector for detecting ions after they have completed a plurality of reflections between the ion mirrors. The two ion mirrors may together form an ion trap. The two ion mirrors may be configured such that ions trapped in the ion trap will oscillate between the ion mirrors (in the first direction X), e.g., indefinitely until they are released for detection. Ion admission and extraction into the ion trap may be controlled by applying suitable voltage(s) to a deflector arranged in the region between the mirrors.

In these embodiments, the ion path may be configured such that ions make a single pass of a first segment of the ion path between the injector and the deflector, then make multiple passes of a cyclic segment of the ion path between the ion mirrors, and then make a single pass of a second segment of the ion path between the deflector and the detector.

In particular embodiments, the analyser is a multi-reflection time-of-flight (MR-ToF) analyser, e.g., which may be configured to operation in a so-called “zoom” mode of operation. Thus, the analyser may comprise two ion mirrors spaced apart and opposing each other in a first direction X, each mirror elongated generally along a drift direction Y between a first end and a second end, the drift direction Y being orthogonal to the first direction X, an ion injector for injecting ions into a space between the ion mirrors, the ion injector located in proximity with the first end of the ion mirrors, and a detector for detecting ions after they have completed a plurality of reflections between the ion mirrors, the detector located in proximity with the first end of the ion mirrors.

The analyser may be configured to analyse ions by:
(i) injecting ions from the ion injector into the space between the ion mirrors, wherein the ions complete a first cycle in which the ions follow a zigzag ion path having plural K reflections between the ion mirrors in the direction X whilst: (a) drifting along the drift direction Y towards the second end of the ion mirrors, (b) reversing drift direction velocity in proximity with the second end of the ion mirrors, and (c) drifting back along the drift direction Y towards the first end of the ion mirrors;
(ii) reversing the drift direction velocity of the ions in proximity with the first end of the ion mirrors such that the ions are caused to complete a further cycle in which the ions follow a zigzag ion path having plural K reflections between the ion mirrors in the direction X whilst: (a) drifting along the drift direction Y towards the second end of the ion mirrors, (b) reversing drift direction velocity in proximity with the second end of the ion mirrors, and (c) drifting back along the drift direction Y towards the first end of the ion mirrors;
(iii) repeating step (ii) one or more times; and then
(iv) causing the ions to travel to the detector for detection.

The analyser may further comprise a deflector or lens located in proximity with the first end of the ion mirrors. The analyser may be configured to analyse ions by:
(i) injecting ions from the ion injector into the space between the ion mirrors, wherein the ions complete a first cycle in which the ions follow a zigzag ion path having plural K reflections between the ion mirrors in the direction X whilst: (a) drifting along the drift direction Y from the deflector or lens towards the second end of the ion mirrors, (b) reversing drift direction velocity in proximity with the second end of the ion mirrors, and (c) drifting back along the drift direction Y to the deflector or lens;
(ii) using the deflector or lens to reverse the drift direction velocity of the ions such that the ions are caused to complete a further cycle in which the ions follow a zigzag ion path having plural K reflections between the ion mirrors in the direction X whilst: (a) drifting along the drift direction Y from the deflector or lens towards the second end of the ion mirrors, (b) reversing drift direction velocity in proximity with the second end of the ion mirrors, and (c) drifting back along the drift direction Y to the deflector or lens;
(iii) repeating step (ii) one or more times; and then
(iv) causing the ions to travel from the deflector or lens to the detector for detection.

The deflector or lens may be located approximately equidistant (in the X direction) between the first and second ion mirrors. The deflector or lens may be arranged along the ion path after the first ion mirror reflection (in the first ion mirror) that the ion beam experiences after being injected from the injector, but before its second ion mirror reflection (in the second ion mirror). Correspondingly, the deflector or lens may be arranged along the ion path before the final ion mirror reflection (in the second ion mirror) that the ion beam experiences before arriving at the detector, but after its penultimate ion mirror reflection (in the first ion mirror).

The multi-reflection time-of-flight (MR-ToF) mass analyser can comprise any suitable type of MR-ToF. For example, the analyser can comprise an MR-ToF having a set of periodic lenses configured to keep the ion beam focused along its flight path, e.g. as described in the article A. Verenchikov, et al., Journal of Applied Solution Chemistry and Modelling, 2017, 6, 1-22, the entire contents of which is hereby incorporated by reference.

However, in particular embodiments, the analyser is a tilted-mirror type multi-reflection time-of-flight mass analyser, e.g., of the type described in U.S. Pat. No. 9,136,101, the contents of which are incorporated herein by reference. Thus, the ion mirrors may be a non-constant distance from each other in the X direction along at least a portion of their lengths in the drift direction Y. The drift direction velocity of ions towards the second end of the ion mirrors may be opposed by an electric field resulting from the non-constant distance of the two mirrors from each other. This electric field may cause the ions to reverse their drift direction velocity in proximity with the second end of the ion mirrors and drift back along the drift direction towards the deflector.

Alternatively, the analyser may be a single focussing lens type multi-reflection time-of-flight mass analyser, e.g., of the type described in UK patent No. 2,580,089, the contents of which are incorporated herein by reference. Thus, the deflector may be a first deflector, and the analyser may comprise a second deflector located in proximity with the second end of the ion mirrors. The second deflector may be configured to cause the ions to reverse their drift direction velocity in proximity with the second end of the ion mirrors and drift back along the drift direction towards the deflector. To do this, a suitable voltage may be applied to the second deflector, e.g., in the manner described in UK patent No. 2,580,089.

In embodiments, the deflector may comprise one or more trapezoid shaped or prism-like electrodes arranged adjacent to the ion beam. This deflector design has a suitably wide acceptance, such that an ion beam that is spread out relatively broadly in the drift direction can be properly received and deflected by the deflector. The deflector may comprise a first trapezoid shaped or prism-like electrode arranged above the ion beam and a second trapezoid shaped or prism-like electrode arranged below the ion beam. The electrode(s) may be angled with respect to the ion beam, such that when suitable (DC) voltage(s) is (are) applied to the electrode(s), the resulting electric field induces a deflection in the ion beam. Suitable deflection voltages are of the order of ±a few volts, ±tens of volts, or ±hundreds of volts.

The deflector should be (and in embodiments is) configured such that it can cause the ion beam to be deflected by a desired (selected) angle. The angle by which the ion beam is deflected by the deflector may be adjustable, e.g., by adjusting the magnitude of a (DC) voltage(s) applied to the deflector. The deflector may be configured such that it can deflect the ion beam by any desired angle.

In embodiments, the method comprises injecting ions from the ion injector into the space between the ion mirrors. The ions may then be reflected in the first ion mirror and may then travel to the deflector. When the ions reach the deflector, the deflector may be configured so as not to deflect the ion beam (or so as to deflect the ion beam by a suitably small angle), e.g., so as not to substantially change the drift direction velocity of the ions, such that the ions continue beyond the deflector and are reflected in the second ion mirror. This may comprise, for example, not applying or removing a voltage from the deflector (or applying a suitably small voltage to the deflector). The ions are then caused to complete a first cycle in which the ions follow a zigzag ion path having plural (K) reflections between the ion mirrors in the direction X whilst: (a) drifting along the drift direction Y from the deflector towards the second end of the ion mirrors, (b) reversing drift direction velocity in proximity with the second end of the ion mirrors, and (c) drifting back along the drift direction Y to the deflector.

After the ions have completed this first cycle, the deflector may be used to reverse the drift direction velocity of the ions such that the ions are caused to complete a further cycle in which the ions follow a zigzag ion path having plural (K) reflections between the ion mirrors in the direction X whilst: (a) drifting along the drift direction Y from the deflector towards the second end of the ion mirrors, (b) reversing drift direction velocity in proximity with the second end of the ion mirrors, and (c) drifting back along the drift direction Y to the deflector. To do this, the deflector may be configured such that the ion beam is deflected, e.g., such that the drift direction velocity of the ions is reversed. This may comprise applying a suitable voltage(s) to the deflector, e.g., during a time period in which it is expected that the ions will arrive back at the deflector. Suitable deflection voltages to reverse the drift direction of the ions are of the order of hundreds of volts.

The step of using the deflector to reverse the drift direction velocity of the ions may be repeated one or more times. Thus, the method may comprise causing the ions to complete plural (N) cycles within the analyser, where in each cycle the ions follow a zigzag ion path having plural (K) reflections between the ion mirrors in the direction X whilst: (a) drifting along the drift direction Y from the deflector towards the second end of the ion mirrors, (b) reversing drift direction velocity in proximity with the second end of the ion mirrors, and (c) drifting back along the drift direction Y to the deflector. The first cycle may be initiated by injecting the ions into the space between the ion mirrors, and after the ions have completed the first cycle, each further cycle may be initiated by using the deflector to reverse the drift direction velocity of the ions.

The method may comprise causing the ions to travel from the deflector to the detector for detection. That is, after the ions have completed the desired (plural) number (N) of cycles within the analyser, the ions may be allowed to travel from the deflector to the detector for detection. To do this, the deflector may be configured so as not to deflect the ion beam (or so as to deflect the ion beam by a suitably small angle), e.g., so as not to substantially change the drift direction velocity of the ions, such that the ions continue beyond the deflector, are reflected in the second ion mirror, and continue on to the detector. This may comprise, for example, not applying or removing a voltage(s) from the deflector (or applying a suitably small voltage to the deflector) such that the ions are caused to exit the deflector in a direction towards the detector. The ions may be reflected in one of the ion mirrors before travelling to the detector.

Upon reaching the detector, the ions may be detected by the detector, e.g., their arrival time may be recorded by the detector. The time-of-flight and/or mass to charge ratio of the ions may then be determined, optionally combined with time-of-flight and/or mass to charge ratio information of other ions, and e.g., a mass spectrum may be produced. It should be noted that not all of the ions that were injected into the analyser may be detected by the detector, e.g., due to inevitable losses at various points between the injector and the detector and/or detector inefficiencies. Thus, as used herein the term “the ions” should be understood as meaning “some, most or all of the ions”.

In these embodiments, the ion path may be configured such that ions make a single pass of a first segment of the ion path between the injector and the deflector or lens, then make multiple passes of a cyclic segment of the ion path between the first and second ends of the ion mirrors, and then make a single pass of a second segment of the ion path between the deflector or lens and the detector.

In the method, the analyser is initially operated in a first mode of operation, and ions are analysed when the analyser is being operated in the first mode of operation (by determining drift times of ions along the ion path) so as to obtain a first set of ion data. The analyser is then switched to operate in a second mode of operation, and ions are analysed when the analyser is being operated in a second mode of operation (by determining drift times of ions along the ion path) so as to obtain a second set of ion data.

The first set of ion data can include plural ion peaks. The number N of passes of the cyclic segment of the ion path taken by ions associated with (i.e., that give rise to) some, most or all ion peaks in the first set of ion data may (by itself) be ambiguous. Similarly, the second set of ion data can include plural ion peaks, and the number N of passes of the cyclic segment of the ion path taken by ions associated with (i.e. that give rise to) some, most or all ion peaks in the second set of ion data may (by itself) be ambiguous. The first and second sets of ion data may be obtained by analysing ions derived from the same sample (e.g. by analysing ions generated from adjacent regions of a sample, and/or by analysing ions generated from a sample at close (adjacent) points in time), e.g. such that ion peaks corresponding to some, most or all (significant) ion peaks in the first set of ion data appear in the second set of ion data.

In the first mode of operation (i) a first electric potential is provided along the first segment of the ion path, (ii) a second electric potential is provided along the cyclic segment of the ion path, (iii) the first segment of the ion path has a first path length, and (iv) the cyclic segment of the ion path has a second path length. The first electric potential may be an electric potential that is provided along some, most or all of the first segment of the ion path. Similarly, the second electric potential may be an electric potential provided along some, most or all of the cyclic segment of the ion path. The first path length may be the path length of the entire first segment. The second path length may be the path length taken by ions in a single cycle (a single loop) of the cyclic segment of the ion path.

In the second mode of operation, at least one of (i) the first electric potential, (ii) the second electric potential, (iii) the first path length, or (iv) the second path length, is altered (changed) with respect to the first mode of operation. Thus, the method may comprise switching the analyser from the first mode of operation to the second mode of operation by at least one of: (i) altering the first electric potential, (ii) altering the second electric potential, (iii) altering the first path length, or (iv) altering the second path length. The alteration may be done such that the effect of the alternation on the drift time of ions along the first segment is proportionally different to the effect of the alternation on the drift time of ions along the cyclic segment. Thus, for example, in particular embodiments, only one of (i) the first electric potential, (ii) the second electric potential, (iii) the first path length, and (iv) the second path length, is altered (changed) with respect to the first mode of operation (and the others are not changed between the first and second modes of operation).

In particular embodiments, where the analyser is a multi-reflecting time-of-flight (MR-ToF) mass analyser (as described above), the method comprises altering the second path length in the second mode of operation by altering the number K of reflections that ions make between the ion mirrors when following the zigzag ion path. This may be done by altering the angle by which the ion beam is deflected by the deflector, i.e., by altering the voltage applied to the deflector. Suitable deflection voltage shifts to alter the angle of the beam in this manner are of the order of a few volts or tens of volts.

Thus, in the first mode of operation, the analyser may be configured such that in each cycle ions make a first number K₁ of reflections between the ion mirrors in the direction X whilst: (a) drifting along the drift direction Y from the deflector towards the second end of the ion mirrors, (b) reversing drift direction velocity in proximity with the second end of the ion mirrors, and (c) drifting back along the drift direction Y to the deflector. In the second mode of operation, the analyser may be configured such that in each cycle ions make a second different number K₂ of reflections between the ion mirrors in the direction X whilst: (a) drifting along the drift direction Y from the deflector towards the second end of the ion mirrors, (b) reversing drift direction velocity in proximity with the second end of the ion mirrors, and (c) drifting back along the drift direction Y to the deflector. The first and second numbers may differ by a small integer amount, such as by one, i.e., |K₁−K₂|=1.

In alternative embodiments, the method comprises altering some, most or all of the first electric potential in the second mode of operation. Thus, in the first mode of operation, the analyser may be configured such that a first electric potential distribution is provided along the first segment of the ion path, and in the second mode of operation, the analyser may be configured such that a different electric potential distribution is provided along the first segment of the ion path.

The first electric potential distribution and the different electric potential distribution may differ such that the electric field experienced by ions passing along the first segment in the first mode of operation is different to the electric field experienced by ions passing along the first segment in the second mode of operation. This difference may cause the time of flight of ions (having a particular m/z) along the first segment in the first mode of operation to be different to the time of flight of ions (having the same particular m/z) along the first segment in the second mode of operation. This time-of-flight difference may be dependent on (e.g., proportional to) the mass to charge ratio (m/z) of the ions. Thus, altering the first electric potential between the first and second modes of operation may result in a mass to charge ratio dependent time-of-flight shift of ions passing along the first segment between the first and second modes of operation.

The first electric potential can be altered between the two modes of operation in any suitable manner. For example, the instrument may comprise a flight tube arranged along at least part of the first segment of the ion path, and the method may comprise altering the first electric potential in the second mode of operation by altering a voltage applied to the flight tube (relative to a voltage applied to the flight tube in the first mode of operation).

Alternatively, the method may comprise altering the first electric potential in the second mode of operation by altering a (pulsed) acceleration field provided by the ion injector (e.g., where the ion injector is an ion trap, by altering a (pulsed) extraction field provided within the ion injector). This may be done by altering one or more (pulsed) acceleration voltage(s) applied to one or more electrode(s) of the ion injector. Thus, in the first mode of operation the ion injector may be configured to accelerate ions along the ion path using a first acceleration field (one or more first acceleration voltage(s)), and in the second mode of operation the ion injector may be configured to accelerate ions along the ion path using a second different acceleration field (one or more second different acceleration voltage(s)). Suitable acceleration fields for the ion injector are of the order of hundreds of V/mm, and suitable acceleration field shifts between the first and second modes of operation are of the order of tens of V/mm.

The method comprises comparing the first set of ion data to the second set of ion data, e.g., so as to identify a first ion peak in the first set of ion data that corresponds to a second ion peak in the second set of ion data. The method may comprise identifying plural such pairs of corresponding ions peaks in the first and second sets of ion data. An ion peak may correspond to another ion peak in that the ions that give rise to those ion peaks may have the same value of the physicochemical property (e.g., may be the same species).

Identifying a first ion peak in the first set of ion data that corresponds to a second ion peak in the second set of ion data may comprise identifying ions peaks that have values of the physicochemical property within an expected (e.g., small) range.

Alternatively, identifying a first ion peak in the first set of ion data that corresponds to a second ion peak in the second set of ion data may comprise:
determining, for each ion peak of one or more ion peaks in the first set of ion data, a first list of possible values of the physicochemical property that ions associated with that ion peak could have;
determining, for each ion peak of one or more ion peaks in in the second set of ion data, a second list of possible values of the physicochemical property that ions associated with that ion peak could have; and comparing the first list to the second list, and identifying, on the basis of the comparison, an ion peak in the first set of ion data that corresponds to an ion peak in the second set of ion data. This may be done by identifying ions peaks that have equal values or values of the physicochemical property within an expected error range.

The method comprises determining the number N of passes of the cyclic segment of the ion path taken by ions associated with (i.e., that give rise to) the corresponding first and second ion peaks. This determination may be done on the basis of the comparison of the first set of ion data to the second set of ion data. For example, determining the number N of passes of the cyclic segment of the ion path taken by ions associated with the corresponding first and second ion peaks may comprise measuring a drift time difference between first and second ion peaks, and using the measured drift time difference to estimate the number N of passes of the cyclic segment of the ion path taken by ions associated with the corresponding first and second ion peaks.

The method comprises using the determined number of passes N to determine a value of the physicochemical property of the ions associated with (i.e., that give rise to) the corresponding first and second ion peaks. This process of determining a value of the physicochemical property of the pair of corresponding ion peaks (based on the determined value of N) may be repeated for each identified pair of corresponding ion peaks of interest.

A further aspect provides a non-transitory computer readable storage medium storing computer software code which when executed on a processor performs the method(s) described above.

A further aspect provides a control system for an analytical instrument such as a mass and/or ion mobility spectrometer, the control system configured to cause the analytical instrument to perform the method(s) described above.

A further aspect provides an analytical instrument, such as a mass and/or ion mobility spectrometer, comprising the control system described above.

A further aspect provides an analytical instrument, such as a mass and/or ion mobility spectrometer, comprising:
an ion analyser configured to analyse ions by determining drift times of ions along an ion path, the ion path comprising at least a first segment, and a cyclic segment, wherein the ion path is configured such that ions make a single pass of the first segment and make one or more passes of the cyclic segment; and
a control system configured to:
operate the analyser in a first mode of operation and analyse ions by determining drift times of ions along the ion path so as to obtain a first set of ion data, wherein in the first mode of operation (i) a first electric potential is provided along the first segment of the ion path, (ii) a second electric potential is provided along the cyclic segment of the ion path, (iii) the first segment of the ion path has a first path length, and (iv) the cyclic segment of the ion path has a second path length;
operate the analyser in a second mode of operation by altering at least one of (i) the first electric potential, (ii) the second electric potential, (iii) the first path length, or (iv) the second path length, and analyse ions by determining drift times of ions along the ion path so as to obtain a second set of ion data;
compare the first set of ion data to the second set of ion data, and identify a first ion peak in the first set of ion data that corresponds to a second ion peak in the second set of ion data;
determine the number N of passes of the cyclic segment of the ion path taken by ions associated with the corresponding first and second ion peaks; and
use the determined number of passes N to determine a physicochemical property of the ions associated with the corresponding first and second ion peaks.

These aspects and embodiments can, and in embodiments do, include any one or more or each of the optional features described herein.

For example, the ion analyser may be a time-of-flight (ToF) mass analyser, and the physicochemical property may be mass to charge ratio (m/z).

Thus, the analyser may comprise:
two ion mirrors spaced apart and opposing each other in a first direction X, each mirror elongated generally along a drift direction Y between a first end and a second end, the drift direction Y being orthogonal to the first direction X;
an ion injector for injecting ions into a space between the ion mirrors, the ion injector located in proximity with the first end of the ion mirrors; and
a detector for detecting ions after they have completed a plurality of reflections between the ion mirrors, the detector located in proximity with the first end of the ion mirrors;

The analyser may be configured to analyse ions by:
(i) injecting ions from the ion injector into the space between the ion mirrors, wherein the ions complete a first cycle in which the ions follow a zigzag ion path having plural K reflections between the ion mirrors in the direction X whilst: (a) drifting along the drift direction Y towards the second end of the ion mirrors, (b) reversing drift direction velocity in proximity with the second end of the ion mirrors, and (c) drifting back along the drift direction Y towards the first end of the ion mirrors;
(ii) reversing the drift direction velocity of the ions in proximity with the first end of the ion mirrors such that the ions are caused to complete a further cycle in which the ions follow a zigzag ion path having plural K reflections between the ion mirrors in the direction X whilst: (a) drifting along the drift direction Y towards the second end of the ion mirrors, (b) reversing drift direction velocity in proximity with the second end of the ion mirrors, and (c) drifting back along the drift direction Y towards the first end of the ion mirrors;
(iii) repeating step (ii) one or more times; and then
(iv) causing the ions to travel to the detector for detection.

Alternatively, the analyser may be an ion mobility analyser, and the physicochemical property may be ion mobility.

### DESCRIPTION OF THE DRAWINGS

Various embodiments will now be described in more detail with reference to the accompanying Figures, in which:

FIG. 1 shows schematically an analytical instrument in accordance with embodiments;

FIG. 2 shows schematically a cyclic ion analyser in accordance with embodiments;

FIG. 3 shows schematically a closed-loop multi-reflection ion trap mass analyser in accordance with embodiments;

FIG. 4 shows schematically a multi-reflection time-of-flight mass analyser in accordance with embodiments;

FIG. 5 shows schematically a multi-reflection time-of-flight mass analyser in accordance with embodiments;

FIG. 6 shows schematically a method of disambiguating spectra obtained from a cyclic ion analyser in accordance with embodiments;

FIG. 7 shows schematically a method of disambiguating spectra obtained from a cyclic ion analyser in accordance with embodiments;

FIG. 8 shows schematically a cyclic ion analyser in accordance with embodiments;

FIG. 9 illustrates how different m/z ions can fall into different numbers of cycles in a cyclic analyser and the consequent convoluted time-of-flight spectrum;

FIG. 10A shows a convoluted time-of-flight spectra, and FIG. 10B shows a recovered mass spectrum found using a method in accordance with embodiments;

FIG. 11 shows images A-D of measured ion peaks, where image A illustrates measured ion peaks for m/z ions acquired when the instrument of FIG. 4 was operated without the zoom mode, and images B-D show measured ion peaks for m/z 524 ions acquired when the instrument of FIG. 4 instrument was operated with the zoom mode in accordance with embodiments;

FIG. 12 shows mass spectra of a calibration solution obtained using a zoom mode in accordance with embodiments; and

FIG. 13 shows data from a disambiguation method in accordance with embodiments.

### DETAILED DESCRIPTION

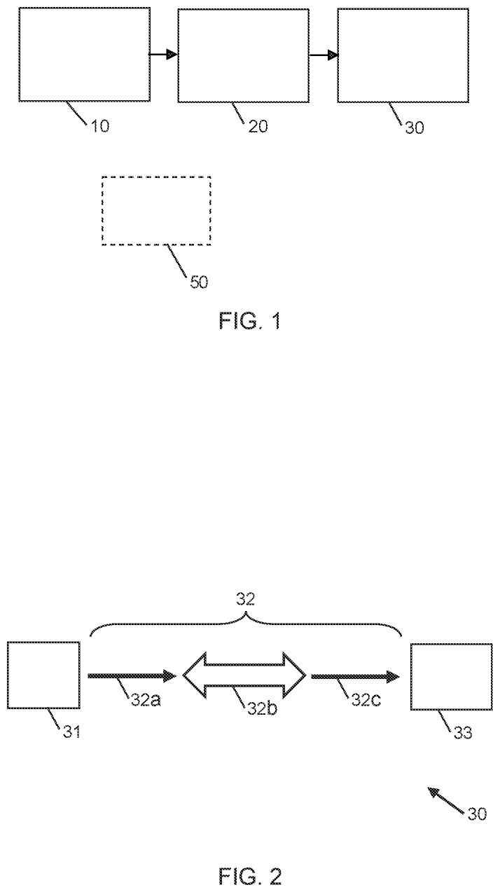

FIG. 1 illustrates schematically an analytical instrument that may be operated in accordance with embodiments. The analytical instrument may be a mass spectrometer (which can optionally include an ion mobility separator) or an ion mobility spectrometer. As shown in FIG. 1, the analytical instrument includes an ion source 10, one or more ion transfer stages 20, and an analyser 30.

The ion source 10 is configured to generate ions from a sample. The ion source 10 can be any suitable continuous or pulsed ion source, such as an electrospray ionisation (ESI) ion source, a MALDI ion source, an atmospheric pressure ionisation (API) ion source, a plasma ion source, an electron ionisation ion source, a chemical ionisation ion source, and so on. In some embodiments, more than one ion source may be provided and used. The ions may be any suitable type of ions to be analysed, e.g., small and large organic molecules, biomolecules, DNA, RNA, proteins, peptides, fragments thereof, and the like.

The ion source 10 may optionally be coupled to a separation device such as a liquid chromatography separation device or a capillary electrophoresis separation device (not shown), such that the sample which is ionised in the ion source 10 comes from the separation device.

The ion transfer stage(s) 20 are arranged downstream of the ion source 10 and may include an atmospheric pressure interface and one or more ion guides, lenses and/or other ion optical devices configured such that some or all of the ions generated by the ion source 10 can be transferred from the ion source 10 to the analyser 30. The ion transfer stage(s) 20 may include any suitable number and configuration of ion optical devices, for example optionally including any one or more of: one or more RF and/or multipole ion guides, one or more ion guides for cooling ions, one or more mass selective ion guides, and so on.

The analyser 30 is arranged downstream of the ion transfer stage(s) 20 and is configured to receive ions from the ion transfer stage(s) 20. The analyser is configured to analyse the ions so as to determine a physicochemical property of the ions, such as their mass to charge ratio, mass, ion mobility and/or collision cross section (CCS). To do this, the analyser 30 is configured to pass ions along an ion path within the analyser 30, and to measure the time taken (the drift time) for ions to pass along the ion path. Thus, the analyser 30 can comprise an ion detector arranged at the end of the ion path, wherein the analyser is configured to record the time of arrival of ions at the detector. The instrument may be configured to determine the physicochemical property of the ions from their measured drift time. The instrument may be configured to produce a spectrum of the analysed ions, such as a mass spectrum or an ion mobility spectrum.

In particular embodiments, the analyser 30 is a time-of-flight (ToF) mass analyser, e.g., configured to determine the mass to charge ratio (m/z) of ions by passing the ions along an ion path within a drift region of the analyser, where the drift region is maintained at high vacuum (e.g., <1×10⁻⁵ mbar). Ions may be accelerated into the drift region by an electric field and may be detected by an ion detector arranged at the end of the ion path. The acceleration may cause ions having a relatively low mass to charge ratio to achieve a relatively high velocity and reach the ion detector prior to ions having a relatively high mass to charge ratio. Thus, ions arrive at the ion detector after a time determined by their velocity and the length of the ion path, which enables the mass to charge ratio of the ions to be determined. Each ion or group of ions arriving at the detector may be sampled by the detector, and the signal from the detector may be digitised. A processor may then determine a value indicative of the time of flight and/or mass-to-charge ratio (“m/z”) of the ion or group of ions. Data for multiple ions may be collected and combined to generate a time of flight (“ToF”) spectrum and/or a mass spectrum.

In alternative embodiments, the analyser 30 is an ion mobility analyser, e.g., configured to determine the ion mobility of ions by passing the ions along an ion path within a drift region of the analyser, where a buffer gas is provided in the drift region. Ions may be urged through the buffer gas by an electric field (or ions may be urged through the drift region by a gas flow where an electric field is arranged to oppose the gas flow) and may be detected by an ion detector arranged at the end of the ion path. Ions having a relatively high mobility will reach the ion detector prior to ions having a relatively low mobility. Thus, ions may separate according to their ion mobility, and may arrive at the ion detector after a time determined by their ion mobility. Each ion or group of ions arriving at the detector may be sampled by the detector, and the signal from the detector may be digitised. A processor may then determine a value indicative of the drift time and/or ion mobility of the ion or group of ions. Data for multiple ions may be collected and combined to generate a drift time spectrum and/or an ion mobility spectrum.

It would also be possible for the analyser 30 to comprise an ion mobility separator coupled to a mass analyser, e.g., where a mass analyser is provided at the end of the ion mobility part of the ion path. In these embodiments, any suitable type of mass analyser may be provided, such as for example a time-of-flight mass analyser, or an electrostatic ion trap mass analyser such as an electrostatic orbital trap, and more specifically an Orbitrap™ FT mass analyser as made by Thermo Fisher Scientific.

It should be noted that FIG. 1 is merely schematic, and that the analytical instrument can, and in embodiments does, include any number of one or more additional components. For example, in some embodiments, the analytical instrument includes a collision or reaction cell for fragmenting or reacting ions, and the ions analysed by the analyser 30 can be fragment or product ions produced by fragmenting or reacting parent ions generated by the ion source 10.

As also shown in FIG. 1, the instrument is under the control of a control unit 50, such as an appropriately programmed computer, which controls the operation of various components of the instrument including the analyser 30. The control unit 50 may also receive and process data from various components including the detector(s) in accordance with embodiments described herein.

In accordance with various embodiments, the analyser 30 is a cyclic analyser. Thus, the ion path within the analyser 30 is made up of at least a first part, and a second cyclic part, wherein the ion path is configured such that ions travelling along the ion path will make only a single pass of the first part and will make one or more (e.g. plural) passes of the second cyclic part before they are detected. This is illustrated schematically by FIG. 2.

As shown in FIG. 2, the analyser 30 includes an ion path 32 provided between an ion injector 31 and an ion detector 33. The ion injector 31 is configured to inject ions into the ion path 32, whereupon ions travel along the ion path 32 and are detected by the detector 33 arranged at the end of the ion path 32. As shown in FIG. 2, the ion path 32 is made up of a first segment 32a, a second cyclic segment 32b, and a third segment 32c. Ions travelling along the ion path 32 between the ion injector 31 and the ion detector 33 make only a single pass of the first segment 32a, followed by one or more (e.g., plural) passes of the second cyclic segment 32b, followed by only a single pass of the third segment 32c. The ion path 32 can include any number of further segments. It would also be possible for the ion path to include only one of the first segment 32a and the third segment 32c.

It will be appreciated that cyclic analysers beneficially allow the length of the ion path 32 taken by ions within the analyser 30 (between the injector 31 and the detector 33) to be increased, thereby increasing the resolution of the analyser 30.

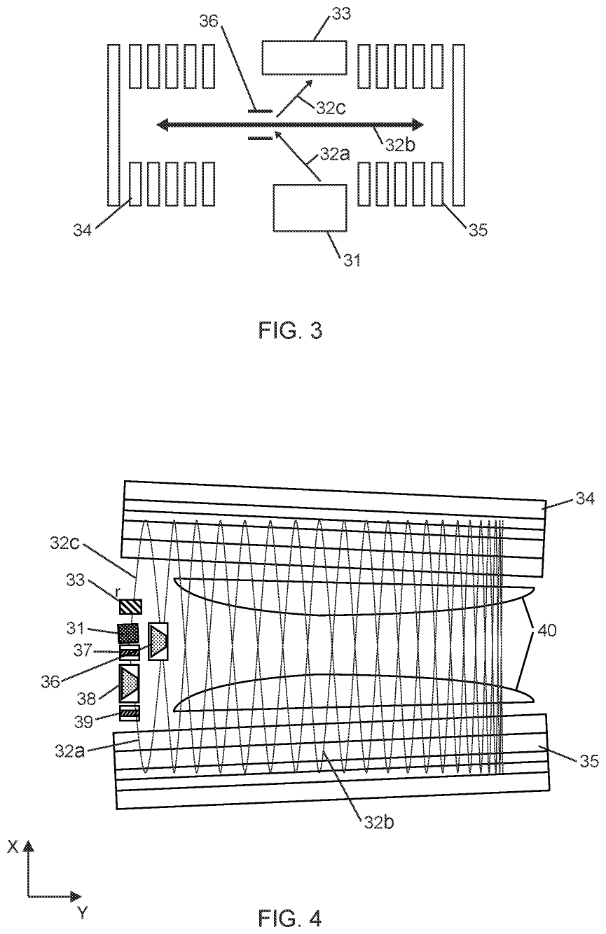

The cyclic analyser 30 can comprise any suitable cyclic ion analyser having an ion path 32 configured such that ions can make plural passes of a cyclic segment 32b of the ion path before being detected. Thus, for example, the analyser 30 can be a cyclic time-of-flight (ToF) mass analyser, a cyclic ion mobility analyser, or a cyclic ion mobility separator coupled to a mass analyser. FIGS. 3-5 illustrate various exemplary embodiments of the cyclic analyser 30.

FIG. 3 illustrates schematically detail of a closed multi-reflection ion trap time of flight mass analyser in accordance with a first exemplary embodiment of the analyser 30.

As shown in FIG. 3, the analyser comprises a pair of ion mirrors 34, 35 that face one another, and that together form an ion trap. The ion mirrors 34, 35 are configured such that ions trapped in the ion trap will oscillate between the ion mirrors 34, 35 on an indefinitely extended (cyclic) ion path 32b until they are released. Ions can be introduced into the ion trap from an ion source (injector) 31 and are eventually detected by an ion detector 33. In the embodiment depicted in FIG. 3, ion admission and extraction into the ion trap is controlled by applying suitable voltage(s) to a deflector 36 arranged in the region between mirrors 34, 35. Alternatively, ion admission and extraction can be achieved by one or both of the ion mirrors 34, 35 being switchable between a trapping mode and a transmissive mode.

In the embodiment depicted in FIG. 3, the ion path 32 is configured such that ions make a single pass of a first segment 32a of the ion path (between the injector 31 and the deflector 36), then make multiple passes of a second cyclic segment 32b of the ion path (between the ion mirrors 34, 35), and then make a single pass of a third segment 32c of the ion path (between the deflector 36 and the detector 33).

In this type of cyclic analyser, the ion flight time can be many milliseconds long, so the resolution can typically reach >100,000, or even >500,000. However, space charge within the limited volume can degrade the analyser performance due to strong coalescence effects.

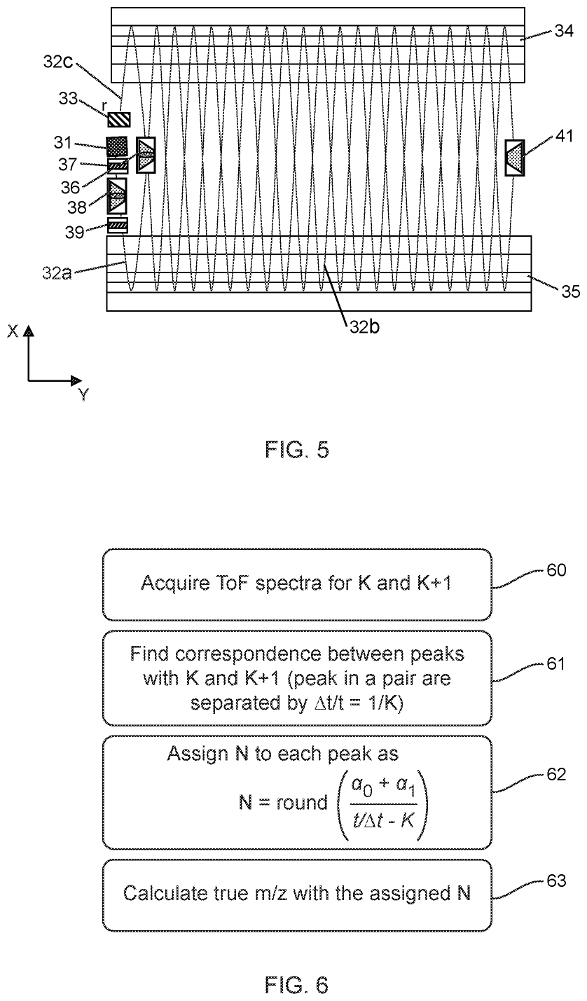

FIGS. 4 and 5 illustrate schematically detail of further exemplary embodiments of the analyser 30. In these embodiments, the analyser 30 is a multi-reflecting time-of-flight (MR-ToF) mass analyser that is operable in a so-called multi-pass “zoom” mode of operation.

As shown in FIGS. 4 and 5, the multi-reflection time-of-flight analyser 30 includes a pair of ion mirrors 34, 35 that are spaced apart and face each other in a first direction X. The ion mirrors 34, 35 are elongated along an orthogonal drift direction Y between a first end and a second end.

An ion source (injector) 31, which may be in the form of an ion trap, is arranged at one end (the first end) of the analyser. The ion source 31 may be arranged and configured to receive ions from the ion transfer stage(s) 20. Ions may be accumulated in the ion source 31, before being injected into the space between the ion mirrors 34, 35. As shown in FIGS. 4 and 5, ions may be injected from the ion source 31 with a relatively small injection angle or drift direction velocity, creating a zig-zag ion trajectory, whereby different oscillations between the mirrors 34, 35 are separate in space. Compared to the analyser of FIG. 3, this has the effect of reducing space charge effects within the analyser.

One or more lenses and/or deflectors may be arranged along the ion path, between the ion source 31 and the ion mirror 35 first encountered by the ions. For example, as shown in FIGS. 4 and 5, a first out-of-plane lens 37, an injection deflector 38, and a second out-of-plane lens 39 may be arranged along the ion path, between the ion source 31 and the ion mirror 35 first encountered by the ions. Other arrangements would be possible. In general, the one or more lenses and/or deflectors may be configured to suitably condition, focus and/or deflect the ion beam, i.e., such that it is caused to adopt the desired trajectory through the analyser.

The analyser also includes another deflector 36, which is arranged along the ion path, between the ion mirrors 34, 35. As shown in FIGS. 4 and 5, the deflector 36 may be arranged approximately equidistant between the ion mirrors 34, 35, along the ion path after its first ion mirror reflection (in ion mirror 35), and before its second ion mirror reflection (in the other ion mirror 34).

The analyser also includes a detector 33. The detector 33 may be any suitable ion detector configured to detect ions, and e.g., to record an intensity and time of arrival associated with the arrival of ion(s) at the detector. Suitable detectors include, for example, one or more conversion dynodes, optionally followed by one or more electron multipliers, and the like.

In its “normal” mode of operation, ions are injected from the ion source 31 into the space between the ion mirrors 34, 35, in such a way that the ions adopt a zigzag ion path having plural reflections between the ion mirrors 34, 35 in the X direction, whilst: (a) drifting along the drift direction Y from the deflector 36 towards the opposite (second) end of the ion mirrors 34, 35, (b) reversing drift direction velocity in proximity with the second end of the ion mirrors 34, 35, and then (c) drifting back along the drift direction Y to the deflector 36. The ions can then be caused to travel from the deflector 36 to the detector 33 for detection.

In the analyser of FIG. 4, the ion mirrors 34, 35 are both tilted with respect to the X and/or drift Y direction. It would instead be possible for only one of the ion mirrors 34, 35 to be tilted, and e.g., for the other one of the ion mirrors 34, 35 to be arranged parallel to the drift Y direction. In general, the ion mirrors are a non-constant distance from each other in the X direction along their lengths in the drift direction Y. The drift direction velocity of ions towards the second end of the ion mirrors is opposed by an electric field resulting from the non-constant distance of the two mirrors from each other, and this electric field causes the ions to reverse their drift direction velocity in proximity with the second end of the ion mirrors and drift back along the drift direction towards the deflector.

The analyser depicted in FIG. 4, further comprises a pair of correcting stripe electrodes 40. Ions travelling down the drift length are slightly deflected with each pass through the mirrors 34, 35 and the additional stripe electrodes 40 are used to correct for the time-of-flight error created by the varying distance between the mirrors. For example, the stripe electrodes 40 may be electrically biased such that the period of ion oscillation between the mirrors is substantially constant along the whole of the drift length (despite the non-constant distance between the two mirrors from). The ions eventually find themselves reflected back down the drift space and focused at the detector 33.

Further detail of the tilted-mirror type multireflection time-of-flight mass analyser of FIG. 4 is given in U.S. Pat. No. 9,136,101, the contents of which are incorporated herein by reference.

In the analyser of FIG. 5, the ion mirrors 34, 35 are parallel to each other. In this embodiment, in order to cause the ions to reverse their drift direction velocity in proximity with the second end of the ion mirrors and drift back along the drift direction towards the deflector, the analyser includes a second deflector 41 at the second end of the ion mirrors 34, 35.

As also shown in FIG. 5, in this embodiment, a lens can be included in the injection deflector 38 and/or in the deflector 36. Thus, the ion beam is allowed to expand a short way into the analyser before meeting a long-focus lens, which has the effect of focussing the ion beam along its length. The lens may be an elliptical drift focusing (converging) lens mounted within the deflector 36. The second deflector 41, which may also include a lens, is used to reverse the beam direction whilst maintaining control of focal properties.

Further detail of the single-lens type multireflection time-of-flight mass analyser of FIG. 5 is given in UK Patent No. GB 2,580,089, the contents of which are incorporated herein by reference.

In the analysers depicted in FIGS. 4 and 5, the ion beam is allowed to spread out relatively broadly (in the drift direction Y) for most of its flight path. This is in contrast, for example, with multi-reflecting time-of-flight (MR-ToF) mass analysers which use a set of periodic lenses to focus the ion beam along its entire flight path, e.g. as described in the article A. Verenchikov, et al., Journal of Applied Solution Chemistry and Modelling, 2017, 6, 1-22. A significant advantage of allowing the ion beam to spread out broadly for most of its flight path is that space charge effects are reduced, which can be a significant problem for time-of-flight analysers. Nevertheless, embodiments described herein are also applicable to other MR-ToF analyser designs, such as the Verenchikov-type MR-ToF analyser.

In the embodiments depicted in FIGS. 4 and 5, the fact that the ion beam is relatively broad in the drift dimension Y means that the deflector 36 should be able to accept such a wide beam without introducing clipping or uneven deflection. A suitable deflector design is a trapezoid shaped or prism-like deflector. Thus, the deflector 36 may comprises a trapezoid shaped or prism-like electrode arranged above the ion beam and another trapezoid shaped or prism-like electrode arranged below the ion beam. The electrodes may be angled with respect to the ion beam. Ions may experience a relatively strong electric field at the edges of the angled electrodes, inducing a deflection. The electrodes may be located out-of-plane of the deflection, thereby allowing them to be easily made to be broad enough to accept a wide ion beam (at least compared to more conventional deflection plates that would sit at either side of the beam).

In embodiments, the multi-reflecting time-of-flight (MR-ToF) mass analyser is operated in a multi-pass “zoom” (cyclic) mode of operation. Ions are made to make multiple cycles within the analyser in the drift direction Y. Increasing the number of cycles N increases the length of the ion path that ions take within the analyser (between the injector and the detector), thereby increasing the resolution of the analyser. In the Verenchikov analyser, this may be done by controlling a voltage onto an entrance lens. For the analysers depicted in FIGS. 4 and 5, the deflector 36 at the front of the analyser, which is normally used to reduce the injection angle and/or optimise the number (K) of oscillations within a single drift pass, may (also) be used to reverse the drift direction velocity of the ions such that the ions are caused to complete a further cycle through the analyser.

Thus, in a multi-pass “zoom” (cyclic) mode of operation, ions are caused to complete plural (N) cycles within the analyser, where in each cycle the ions drift in the drift direction Y from the deflector 36 (or entrance lens) towards the opposite (second) end of the ion mirrors 34, 35, and then back to the deflector 36 (or entrance lens). In each cycle, the ions also complete plural (K) reflections between the ion mirrors in the X direction. Thus, in each cycle, the ions adopt a zigzag ion path 32b through the space between the ion mirrors 34, 35.

In the analysers depicted in FIGS. 4 and 5, an initial cycle may be initiated by injecting the ions from the injector 31 into the space between the ion mirrors 34, 35. The ions may be reflected in one of the ion mirrors 35 and may then travel to the deflector 36. No voltage may be applied to the deflector 36 (or else an appropriate (e.g., relatively small) voltage may be applied to the deflector) such that the ions are caused to exit the deflector 36 in a direction towards the second end of the ion mirrors. Upon existing the deflector 36, the ions adopt a zigzag ion path 32b having plural (K) reflections between the ion mirrors 34, 35 in the direction X whilst: (a) drifting along the drift direction Y from the deflector 36 towards the second end of the ion mirrors, (b) reversing drift direction velocity in proximity with the second end of the ion mirrors, and (c) drifting back along the drift direction Y to the deflector 36.

After the ions have completed this initial cycle, each further cycle is initiated by using the deflector 36 to reverse the drift direction velocity of the ions (in proximity with the first end of the ion mirrors). To do this, an appropriate voltage may be applied to the deflector 36 that causes ions to leave the deflector 36 with a drift direction velocity opposite to the drift direction velocity with which the ions originally entered the deflector 36.

After the ions have completed the desired (plural) number (N) of cycles within the analyser, the ions are allowed to travel from the deflector 36 to the detector 33 for detection. To do this, the voltage may be removed from the deflector 36 (or else an appropriate voltage may be applied to the deflector) such that the ions are caused to exit the deflector 36 in a direction towards the detector 33. The ions may be reflected in (the other) one of the ion mirrors 34 before travelling to (and being detected by) the detector 33.

In the embodiments depicted in FIGS. 4 and 5, the ion path is configured such that ions make a single pass of a first segment 32a of the ion path (between the injector 31 and the deflector 36 via an ion mirror 35), then make multiple passes of a second cyclic segment 32b of the ion path (between the deflector 36 and the deflector 36 via the opposite (second) end of the ion mirrors 34, 35), and then make a single pass of a third segment 32c of the ion path (between the deflector 36 and the detector 33 via the other ion mirror 34).

Although FIGS. 3-5 illustrate exemplary embodiments of the cyclic analyser 30, it will be understood that various alternative embodiments are possible. For example, the analyser 30 can instead be a cyclic ion mobility analyser or a cyclic ion mobility separator coupled to a mass analyser.

In these embodiments, the cyclic ion mobility analyser or the cyclic ion mobility separator may comprise a closed-loop ion separator, e.g., of the type described in UK Patent Application No. GB 2,562,690, the entire contents of which is incorporated herein by reference. Ions may be caused to separate according to their ion mobility over a fixed integer number of cycles around the ion mobility separator. A gate may be provided which may be closed to allow multi-pass operation. The gate may be opened to allow ions to exit the ion mobility separator after ions have made one or more circuits of the ion mobility separator. Using a cyclic ion mobility separator can allow a higher degree of separation, and so higher ion mobility resolution.

In these embodiments, the ion path may be configured such that ions make a single pass of a first segment of the ion path (before the closed-loop ion separator), then make multiple passes of a second cyclic segment of the ion path (within the closed-loop ion separator), and then make a single pass of a third segment of the ion path (after the closed-loop ion separator).

A common benefit between the various types of cyclic analysers (in which ions are made to make plural N repeated cycles along an ion path within the analyser) is that increasing the number of cycles N increases the length of the ion path that ions take within the analyser, thereby increasing the resolution of the analyser.

However, a common problem is that during multiple cycles N through the analyser, faster moving (e.g., lighter) ions can overtake (e.g., lap) slower moving (e.g., heavier) ions. This complicates the resulting spectra and can make it difficult to accurately determine the desired physicochemical property (e.g., m/z or ion mobility) of all the detected ions, because the number of cycles N taken by each ion peak in a spectrum becomes ambiguous.

Thus, embodiments provide methods of disambiguating a spectrum produced by a cyclic ion analyser. By comparing two sets of ion data that have been obtained under different analyser settings, the number of passes N through the cyclic segment 32b of the ion path 32 taken by ions contributing to an ion peak can be determined, thereby allowing the physicochemical property of those ions to be unambiguously determined and assigned to the ion peak.

Although parts of the following discussion are described in terms of the MR-ToF analysers of FIGS. 4 and 5, the skilled person will understand that similar considerations can be applied to the various other types of cyclic analyser such as cyclic ToF analysers, and cyclic ion mobility separators.

The ion path depicted in FIGS. 4 and 5, for example, is made by all ions with the mass to charge ratio in the range from (m/z)₁ to (m/z)₂. The deflector 36 is to be switched from Mode 1 (deflection from source 31 to the loop) to Mode 2 (deflection from loop back to the loop) and finally to the Mode 3 (deflection from the loop to the detector 33). The switching times will be denoted as t₁₂ and t₂₃, respectively. The zero time is assumed to be the moment of injection.

The first switching between Modes 1 and 2 should happen not earlier than the heaviest ion (m/z)₂ passes the deflector 36 for the first time, and not later than the lightest ion (m/z)₁ makes a₀+K oscillations, where K is the number of oscillations per loop (between subsequent passages of the deflector 36) and a₀ represents a portion of an oscillation before the ion source 31 and the first passage of the deflector 36. Otherwise, the lightest ions will not be set to the next loop properly. This gives the double inequality:

a₀T₂≤t₁₂≤(a₀+K)T₁ (a)

where T₁ and T₂ are the times of oscillation for lightest and the heaviest ions correspondingly. In the embodiments of FIGS. 4 and 5, a₀≈1/2.

The second switching from Mode 2 to Mode 3 should happen not earlier than the heaviest ion makes a₀+(N−1)K oscillations, where N is the intended number of loops. Otherwise, the heaviest ion will exit the loop before all loops are made. On the other hand, the second switching should be not later than the lightest ion makes a₀+NK oscillations, otherwise this ion will stay in the analyser for the next, unwanted, loop. This double inequality reads:

(a₀+NK−T₂≤t₂₃≤(a₀+NK)T₁ (b)

Both inequalities (a) and (b) impose upper bounds for the ratio of T₂ and T₁ under which for a pair t₁₂ and t₂₃ exists; and the bound from (b) is stronger (lower) than that from (a) for any N>1:

$$\frac{{T}_{2}}{{T}_{1}} \leq {( \frac{{T}_{2}}{{T}_{1}} )}_{max} = \frac{{a}_{0} + N K}{{a}_{0} + N K - K}$$

As the time of flight is proportional to the square root of m/z, this inequality translates directly to the maximum unambiguous mass range (UMR) as:

$$\frac{{( m / z )}_{2}}{{( m / z )}_{1}} \leq U M R = {( \frac{{a}_{0} + N K}{{a}_{0} + N K - K} )}^{2}$$

To realize the full UMR, the switching time t₂₃ must be:

t₂₃=(a₀+NK)T₁=(a₀NK−K)T₂

The first switching time leaves some freedom to define. It may be assumed, for example, its minimal possible value may be adopted t₁₂=a₀T₂, which allows for electronic ripples before the lightest ion comes to the deflector for the next time.

Table 1 shows simulations of a mass analyser with a 1.25 m effective oscillation distance and twenty oscillations per loop. The resolution is calculated in terms of peak full-width-half-maximum. The collapse in m/z range is rather pronounced as the number of loops is increased.

TABLE 1

| No. of loops | FWHM/ns | Resolution, K | Unambiguous Mass Range |
|---|---|---|---|
| No zoom | 1.7 | 125 | Source |
| | | | Limited >15x |
| 2x | 6.5 | 65 | 3.9x |
| 3x | 2.2 | 280 | 2.23x |
| 4x | 7.0 | 120 | 1.77x |
| 5x | 3.0 | 340 | 1.56x |

The m/z range of ions entering the analyser 30 could be limited, e.g., via use of the switchable deflector, mass filter (e.g., quadrupole mass filter), or otherwise, to approximately match their m/z range to the UMR of the zoom method and to thereby remove ambiguity in m/z assignment. This is, however, rather wasteful for ion transmission and more efficient methods may be preferable to maintain sensitivity.

Accordingly, disambiguation of complex spectra in accordance with embodiments is in general preferable, whereby the correct number of drift reflections is assigned to individual ion peaks, and from there the accurate m/z for each ion peak is determined.

One possible approach to disambiguation would be to directly assign the correct number of cycles N for each ion peak based on the resolution of that peak. From the resolution shifts observed in Table 1, this at first appears as a rather appealing approach. Similarly, m/z dependent properties (such as single ion detector response, spacing between different charge states, isotopes or common fragmentation routes such as loss of ammonia or water, and so on) could be used to pre-assign an approximate m/z to individual ion peaks, and thus cycle number. Comparison to a survey scan with no zoom mode is also possible, particularly for MR-ToF analysers with drift separation, where even the survey scan is very highly resolving and mass accurate. However, in practice these approaches are significantly complicated by space charge effects for intense ion peaks, and statistical problems for small ion peaks.

In accordance with embodiments, disambiguation of cyclic analyser spectra (such as ToF mass analyser spectra or ion mobility analyser spectra), is done by varying the time-of-flight separately on the ion path segments which are included (32b) or not included (32a, 32c) in the repeating loop.

As used herein, the “effective ion path” is defined as the time-of-flight times the ion velocity under a nominal acceleration voltage. The effective ion path may be varied either by altering the ion path length directly, or by changing a voltage(s) which changes the time-of-flight.

Referring again to FIG. 2, the effective ion path along the whole ion trajectory 32 is comprised of three parts:

L=L₀+LₘN+L₁

where L₀ and L₁ correspond to the non-repeated segments 32a, 32c outside of the loop (e.g., in FIGS. 3-5, corresponding respectively to the path 32a between the injector 31 and the switchable deflector 36, and to the path 32c from this deflector 36 to the ion detector 33). The path Lₘ is the effective length of the segment 32b which is repeated N times in the loop.

When the effective ion paths L₀, Lₘ, and L₁ are modified proportionally, the measured time-of-flight will change in the same proportion for every ion, regardless of how many loops N the ion makes. However, changing Lₘ by ΔLₘ, while leaving L₀+L₁ unaltered modifies the time-of-flight by Δt in the proportion:

$$\frac{Δ t}{t} = \frac{Δ {L}_{m} N}{{L}_{0} + {L}_{m} N + {L}_{1}}$$

which is resolvable for N as:

$$N = \frac{{L}_{0} + {L}_{1}}{{L}_{m}} {( \frac{Δ {L}_{m}}{{L}_{m}} \frac{t}{Δ t} - 1 )}^{- 1} \qquad ( eq . Na )$$

In the other case that the sum L₀+L₁ is changed by ΔL₀ and Lₘ is unchanged, the relative time of flight shift is:

$$\frac{Δ t}{t} = \frac{Δ {L}_{0}}{{L}_{0} + {L}_{m} N + {L}_{1}}$$

which yields another formula for N:

$$N = \frac{{L}_{0} + {L}_{1}}{{L}_{m}} ( \frac{Δ {L}_{0}}{{L}_{0} + {L}_{1}} \frac{t}{Δ t} - 1 ) \qquad ( eq . Nb )$$

Therefore, in both cases, the number of loops N can be determined based on the measured time shift Δt for an ion peak detected in the moment t after injection. With the number of oscillations N known, the time of flight t can be converted into the mass-to-charge ratio (or ion mobility) using a normal conversion.

Thus, in embodiments, a first set of ion data is obtained when operating the analytical instrument in a first mode of operation, and a second set of ion data is obtained when operating the analytical instrument in a second, different mode of operation. The first and second sets of ion data may be obtained by analysing ions derived from the same sample (e.g. by analysing ions generated from adjacent regions of a sample, and/or by analysing ions generated from a sample at close (adjacent) points in time), e.g. such that ion peaks corresponding to some, most or all (significant) ion peaks in the first set of ion data appear in the second set of ion data.

The first mode of operation and the second mode of operation differ in respect of at least one parameter of the analyser 30. In effect, the analyser's ion path 32 is separated into two regions, one with a flight path 32b affected by the number N of passes, and at least one 32a, 32c unaffected. A parameter change is applied between the two modes of operation that disproportionately alters the drift time through one of these segments versus the other. Thus, the proportional change in drift time depends on how many passes N through the cyclic segment 32b an ion undergoes. In embodiments, either the effective ion path in the loop Lₘ is altered between the two modes of operation, or the effective ion path outside the loop L₀+L₁ is altered between the two modes of operation.

An effective ion path can be changed either by altering the ion path length directly, or by changing a voltage(s) which changes the time-of-flight. Thus, in the first mode of operation (i) a first electric potential is provided along the first segment 32a, 32c of the ion path, (ii) a second electric potential is provided along the cyclic segment 32b of the ion path, (iii) the first segment of the ion path 32a, 32c has a first path length, and (iv) the cyclic segment of the ion path 32b has a second path length. In the second mode of operation at least one of: (i) the first electric potential, (ii) the second electric potential, (iii) the first path length, or (iv) the second path length; is changed relative to the first mode of operation, e.g. such that one of the effective ion path in the loop Lₘ and the effective ion path outside the loop L₀+L₁ is altered relative to the first mode of operation.

This parameter change will induce a time shift Δt for each ion peak between the two sets of ion data. Thus, the first set of ion data is compared to the second set of ion data so as to identify corresponding (matching) ion peaks. For each identified ion peak pair of interest, the time shift Δt for that ion peak pair between the two sets of data is measured. The number of loops N for each peak is then estimated from the measured time shift Δt (e.g., using the equations described above), and N is used to calculate the mass-to-charge ratio (or other physiochemical property) of the ions corresponding to the ion peak.

Various exemplary embodiments for altering either the effective ion path in the loop Lₘ, or the effective ion path outside the loop L₀+L₁ are described below. It will be understood, however, that various alternatives are possible, e.g., depending on the particular design of cyclic ion analyser 30.

In a first exemplary embodiment, the path length of the cyclic segment 32b of the ion path is altered between the first and second modes of operation.

In the multi-reflection analyser of FIGS. 4 and 5, the effective length of the loop can be changed by altering the number of reflections K between the ion mirrors 34, 35 made by ions per cycle, i.e. by changing the number of reflections K in the X direction made by the ions as they (a) drift along the drift direction Y from the deflector 36 towards the second end of the ion mirrors, (b) reverse drift direction velocity in proximity with the second end of the ion mirrors, and (c) drift back along the drift direction Y to the deflector 36. This can be done by suitably altering the voltage applied to the deflector 36 between the two modes of operation, i.e., such that ions leave the deflector 36 with slightly different angles between the two modes of operation. Suitable voltage shifts are of the order of a few volts or tens of volts. In the case of the tilted mirrors-type analyser of FIG. 4, the change in K can also or instead be done by adjusting the voltages applied to the stripe electrode 40.

In embodiments, the number of reflections K between the ion mirrors 34, 35 is changed by ±1 between the two modes of operation, and corresponding time shifts Δt are measured for individual ion peaks. As the number of passes N is low (normally below <6), the time shifts Δt may be measured with moderate precision, and the exact number of loops N can be determined by rounding (eq. Na) to the nearest integer.

The effective length of the loop Lₘ is proportional to K, which leads to a relative change ΔLₘ/Lₘ=1/K when the number of oscillations K is increased by one. In this case, the formula (eq. Na) reads:

$$N = \frac{{a}_{0} + {a}_{1}}{K} {( \frac{t}{K Δ t} - 1 )}^{- 1} = \frac{{a}_{0} + {a}_{1}}{\frac{t}{Δ t} - K} \qquad ( eq . N . dk )$$

where a₀ is the fraction of an oscillation between injection and the first passage through the switchable deflector 36, and a₁ is the fraction of an oscillation after exiting the loop and before impinging on the detector 33. In the analyser shown in FIGS. 4 and 5, these fractions are around 0.5 and 0.45 respectively.

Table 2 shows an example of this disambiguation algorithm applied to a ToF spectrum of the Flexmix calibration mixture. The low m/z ions are set to arrive at the detector after making N=2 loops, each loop containing K₁=21 oscillations. Corresponding times of flight are presented in the first column. Some ions with higher m/z (predominantly Ultramark ions), however, make one more loop, N=3, due to their lower propagation velocities. To assign a correct number of loops to each peak, the system was turned to a mode with K₂=22 oscillations in each loop, and corresponding times of flight for each of the peaks were detected. These are given in the second column. The formula (eq.N.dk) was applied to estimate the values of N* from the time-of-flight differences, and these values were rounded to the nearest integer. Finally, the m/z ratios were calculated with the formula:

$$\frac{m}{z} = ( 1 + {c}_{N} ) \times 2 {U}_{0} \times {( \frac{T o F}{{L}_{0} + {L}_{1} + N {L}_{m}} )}^{2} \qquad ( eq . mz )$$

where U₀ is the acceleration voltage and CN<<1 is a calibration coefficient which was a-priori experimentally defined for each number of loops N=2 and 3.

TABLE 2

| Detected ToF t, μs | | | | | |
|---|---|---|---|---|---|
| K = 21 | K = 22 | t/Δt | N* | N | m/z, Th |
| 1938.553 | 1851.682 | 21.315 | 3 | 3 | 393.224318 |
| 1941.024 | 1854.042 | 21.315 | 3.001 | 3 | 394.227718 |
| 1963.009 | 1875.042 | 21.315 | 3.000 | 3 | 403.208721 |
| 1992.4 | 1903.708 | 21.464 | 2.037 | 2 | 922.008848 |
| 2197.923 | 2100.044 | 21.456 | 2.077 | 2 | 1121.99485 |
| 2238.375 | 2138.068 | 21.315 | 3.0004 | 3 | 524.264857 |
| 2240.516 | 2140.113 | 21.315 | 3.0013 | 3 | 525.268358 |
| 2293.732 | 2191.626 | 21.464 | 2.0380 | 2 | 1221.9884 |
| 2294.673 | 2192.525 | 21.464 | 2.0382 | 2 | 1222.99131 |
| 2385.733 | 2279.534 | 21.465 | 2.0356 | 2 | 1321.9844 |
| 2386.639 | 2280.397 | 21.464 | 2.0384 | 2 | 1322.98508 |
| 2438.161 | 2328.901 | 21.315 | 3.0007 | 3 | 622.027987 |

In embodiments, the fractional part of N* comes from a limited precision of calibration. Nevertheless, the assignment of the integer N as the rounded value N* is unambiguous. The fewer loops that need to be distinguished from one another, the more reliable the disambiguation procedure becomes.

An advantage of the above-described “zoom” mode in the analyser of FIG. 4 or 5 is that the analyser has a relatively long fight length Lₘ per loop (tens of meters) and a relatively small number of loops (N=1 . . . 5). For example, a 15× m/z range provided by the ion source 10, with the zoom mode configured to give the highest m/z ions two drift passes (N=2), means that the lowest m/z ions will make four passes (N=4), so that the ambiguity is only whether ions are making N=2, 3 or 4 passes.

FIG. 6 is a flowchart illustrating a disambiguation method according to these embodiments. As shown in FIG. 6, in the method, first and second mass spectra are acquired with the analyser being operated with different numbers of ion oscillations (K and K+1) per cycle through the analyser (step 60). Corresponding pairs of ion peaks in the two spectra are then identified (step 61), and the number N of passes of the cyclic segment of the ion path taken by ions associated with each pair of corresponding ion peaks is estimated (step 62). Finally, N is used to calculate the true m/z of the ions (step 63).

Another approach to determine the number of loops from the times of flight under different numbers of oscillations K per loop is to calculate a list of possible mass to charge ratios for each ion peak (from eq.mz) under different assumptions about the possible number of loops N. This gives several possible values

$$\frac{m}{z} ( N , K ) ,$$

where N is a candidate number of loops and K=K₁, K₂. Only for the correct value of N, the candidate values

$$\frac{m}{z} ( N , {K}_{1} )$$

and

$$\frac{m}{z} ( N , {K}_{2} )$$

are (approximately) equal (e.g. within a narrow tolerance, like 10 ppm), while incorrect assumptions about N result in substantially different values.

As illustrated in Table 3A and 3B, only one candidate N (3 and 2 correspondingly) give close candidates for m/z under different values of K. These candidate values are assumed to correct, and all other m/z calculated with other assumptions about the number of loops are discarded as being incorrect.

TABLE 3A

| Exact m/z = 524.26 | K = 21 | K = 22 |
|---|---|---|
| Measured ToF, μs | 2138.068 | 2238.375 |

| | | |
|---|---|---|
| Assumed #loops, N | Candidates for m/z, Th | Δm/z, Th |

| | | | |
|---|---|---|---|
| 1 | 4451.092 | 4462.579 | 11.487 |
| 2 | 1162.336 | 1163.102 | 0.766 |
| 3 (correct) | 524.2646 | 524.2647 | 0.0001 |
| 4 | 297.0923 | 296.9936 | −0.0987 |
| 5 | 190.9889 | 190.8871 | −0.1018 |

TABLE 3
Table 3B

| Exact m/z = 922.01 | K = 21 | K = 22 |
|---|---|---|
| Measured ToF, μs | 1903.708 | 1992.400 |

| | | |
|---|---|---|
| Assumed #loops, N | Candidates for m/z, Th | Δm/z, Th |

| | | | |
|---|---|---|---|
| 1 | 3530.773 | 3537.682 | 6.909 |
| 2 (correct) | 922.0088 | 922.0419 | 0.0331 |
| 3 | 415.8663 | 415.6076 | −0.2587 |
| 4 | 235.6648 | 235.4398 | −0.225 |
| 5 | 151.4996 | 151.3246 | −0.175 |

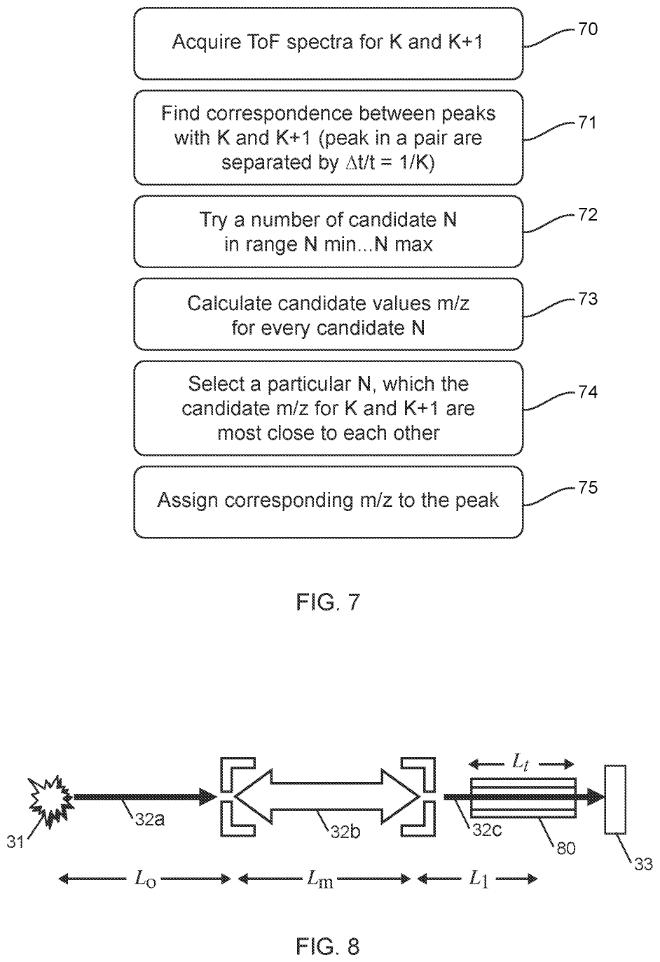

FIG. 7 is a flowchart illustrating a disambiguation method according to these embodiments. As shown in FIG. 7, in the method, first and second mass spectra are acquired with the analyser being operated with different numbers of ion oscillations (K and K+1) per cycle through the analyser (step 70). Pairs of corresponding ion peaks are identified (step 71). In respect of each candidate value of N (step 72), for each peak a candidate m/z value is calculated (step 73). Thus, a list of the possible m/z values for each ion peak of interest is generated. Matching pairs of ion peaks between the two spectra are then identified to determine the accurate N for each pair of corresponding ion peaks (step 74). Finally, the unambiguous m/z of each matching pair of ion peaks is determined and assigned to each ion peak (step 75).

In some embodiments, because of the possibility of some peaks disappearing because of the shift of K, e.g., due to ions being present within the deflector 36 during the voltage switch, it may be beneficial to use more than two values of K, at cost of overall acquisition speed. Disappearance of ion peaks in the spectrum can also or instead be used to provide information for disambiguation, because the m/z values that disappear can be calculated based on the deflector size, switching speed/times, and so on.

In general, embodiments can comprise analysing ions in a third mode of operation (by determining drift times of ions along the ion path) so as to obtain a third set of ion data, wherein in the third mode of operation at least one of: (i) the first electric potential, (ii) the second electric potential, (iii) the first path length, or (iv) the second path length; is changed relative to the first and/or second mode of operation, comparing the third set of ion data to the first and/or second set of ion data, and determining, on the basis of the comparison, the number N of passes of the second part of the ion path taken by ions associated with the corresponding ion peaks.

In a second exemplary embodiment, disambiguation is done by comparing flight times between two spectra where the non-reflecting segment of the flight path has been altered by changing an electric potential of the non-reflecting segment of the flight path.

FIG. 8 shows schematically a simplified (e.g., MR-ToF) analyser layout, which incorporates a short section of flight tube 80 before the detector 33. The flight tube 80 could straightforwardly be incorporated into a detector arrangement, e.g., as part of a so-called post-accelerator, which comprises an arrangement of suitably biased electrodes configured to accelerate ions onto a conversion dynode. The flight tube 80 allows the potential to be varied to shift flight time of ions in the non-reflecting segment of the ion path 32c before the detector 33. FIG. 8 also shows separation of the ion flight path 32 into several sections, injection L₀, the reflecting part Lₘ, and extraction to the detector L₁ with the incorporated flight tube Lₜ.

The time-of-flight shift caused by a voltage v applied to the flight tube 70 is proportional to \sqrt{m/z}, and does not depend on the number of cycles N. Measuring the time-of-flight spectrum with two (or more) values of v allows independent assessment of m/z. Therefore, the number of cycles N can be assigned to each peak. Accurate values of m/z can then be determined from the perplexed time-of-flight spectrum, and the number of cycles that was assigned for each ion peak of interest.

In the schematic diagram of FIG. 8, an ion with mass-to-charge ratio μ=m/z reaches the second mirror at the moment of time:

$${t}_{n} ( μ ) = \sqrt{\frac{μ}{2 {ε}_{0}}} [ {L}_{0} + ( 2 n + 1 ) {L}_{m} ]$$

where ε₀ is the acceleration voltage and L₀ and Lₘ are effective lengths. Let the second mirror abruptly switch from a reflection mode to a transmission mode in the time moment T₂. The number of reflections completed in the second mirror before T₂ is:

$$N ( μ ) = 〚 \frac{1}{2 {L}_{m}} ( {T}_{2} \sqrt{\frac{2 {ε}_{0}}{μ}} - {L}_{0} + {L}_{m} ) 〛 \qquad ( equation Nμ )$$

where the double brackets [[ . . . ]] denote the integer part. The time when the ion is detected is:

$${t}_{D} ( μ ) = \sqrt{\frac{μ}{2 {ε}_{0}}} ( {L}_{0} + ( 2 N ( μ ) + 1 ) {L}_{m} + {L}_{1} )$$

As the number of cycles N decreases step-wise with the mass-to-charge ratio μ, the function t_{D}(μ) is non-monotonous. This means that a ToF spectrum t_{D}(μ) is ambiguous, and a peak located at t_{D} may correspond to a number of different mass-to-charge ratios μ.

Intervals of μ which correspond to a particular integer N(μ) are referred to as unambiguous mass intervals. For N cycles, the corresponding unambiguous interval ranges from M_{N+1} to M_{N}, where:

$${M}_{N} = {T}_{2} \sqrt{\frac{2 {ε}_{0}}{μ}} - {L}_{0} + {L}_{m} = \frac{2 {T}_{2}^{2} {ε}_{0}}{{( ( 2 N - 1 ) {L}_{m} + {L}_{0} )}^{2}}$$

The unambiguous mass range is, correspondingly:

$${UMR}_{N} = \frac{{M}_{N}}{{M}_{N + 1}} = {( \frac{2 N + {L}_{0} / {L}_{m} + 1}{2 N + {L}_{0} / {L}_{m} - 1} )}^{2}$$

Consider the short flight tube 80 with length Lₜ situated between the second mirror and the detector 33 and biased with a voltage v<<ε₀. When the voltage is applied, the peak appears shifted by:

$$\begin{matrix}Δ {t}_{D} ( μ ) = \sqrt{\frac{μ}{2 ( {ε}_{0} - v )}} {L}_{t} - \sqrt{\frac{μ}{2 {ε}_{0}}} {L}_{t} \\ = \sqrt{\frac{μ}{2 {ε}_{0}}} {L}_{t} ( \frac{1}{\sqrt{1 - v / {ε}_{0}}} - 1 ) ≅ \frac{v}{2 {ε}_{0}} \sqrt{\frac{μ}{2 {ε}_{0}}} {L}_{t}\end{matrix}$$

As v<<ε₀, the peak width is not widened much, and the centroid shift is measurable. This allows a rough estimation of the inverse ion velocity and the mass-to-charge ratio μ as:

$$\sqrt{\frac{{μ}^{*}}{2 {ε}_{0}}} ≅ {( \sqrt{\frac{{ε}_{0}}{{ε}_{0} - v}} - 1 )}^{- 1} \frac{Δ {t}_{D}}{{L}_{t}} ≅ \frac{2 {ε}_{0}}{v} {( \frac{v}{{ε}_{0}} )}^{- 1} \frac{Δ {t}_{D}}{{L}_{t}} ,$$

$${μ}^{*} ≅ \frac{{( 2 {ε}_{0} )}^{3}}{{L}_{t}^{2}} {( \frac{Δ {t}_{D}}{v} )}^{2}$$

The precision is low but is sufficient to determine the number of cycles N for a particular peak. To this end, the estimate μ* is to be substituted into the formula (equation Nμ)N(μ*)=[[N*]], where:

$${N}^{*} ≅ \frac{1}{2 {L}_{m}} ( \frac{v}{2 {ε}_{0}} \frac{{T}_{2}}{Δ {t}_{D}} {L}_{t} - {L}_{0} + {L}_{m} )$$

The accurate μ is then determined as:

$$μ = 2 {{ε}_{0} ( \frac{{t}_{D}}{{L}_{0} + ( 2 〚 {N}^{*} 〛 + 1 ) {L}_{m} + {L}_{1}} )}^{2}$$

where N* is rounded down.

Thus, in these embodiments a first set of ion data is obtained when operating the analytical instrument in a first mode of operation, and a second set of ion data is obtained when operating the analytical instrument in a second mode of operation, where in the second mode of operation the electric potential along the first (and/or third) segment 32a, 32c of the ion path is changed relative to the first mode of operation. This change induces a time shift Δt for each ion peak between the two sets of ion data, which is used to estimate the number of cycles N for each peak, and so the mass-to-charge ratio (or other physiochemical property), e.g., in the manner described above.

In the embodiments illustrated by FIG. 8, it would instead be possible to position the flight tube 80 in the ion path 32a between the source 31 and the first mirror.

Another embodiment is to alter the acceleration field provided by the ion injector 31 for accelerating ions along the ion path. Where the ion injector is an ion trap, this may comprise altering the extraction field provided within the ion trap for accelerating ions from the ion trap along the ion path (e.g., where, in this embodiment, at least part of the first segment 32a of the ion path can be considered to be within the ion trap). Suitable extraction fields are of the order of hundreds of V/mm, and suitable extraction field shifts between the first and second modes of operation are of the order of tens of V/mm.

It should also be noted that, if the voltage applied to the flight tube 80 is relatively small, the number of cycles N will be preserved for the vast majority of ion peaks, except ion peaks located close to M_{N}.

These embodiments can also be straightforwardly implemented in cyclic ion mobility spectrometry (which measures time-of-flight through a gas filled drift path). For example, UK Patent Application No. GB 2,562,690 describes an instrument combining a cyclic ion mobility analyser and a short linear drift tube that could straightforwardly be adapted to shift total drift times in a similar manner to that described above.

Although the above exemplary embodiments have been described in terms of changing (between the first and second modes of operation) either (i) the electric potential along the non-cyclic segment 32a, 32c of the ion path, or (ii) the path length of the cyclic segment 32b of the ion path, it will be appreciated that it would instead be possible to change either (iii) the electric potential along the cyclic segment 32b of the ion path (e.g. by including a flight tube along the cyclic segment 32b of the ion path), or (iv) the path length of the non-cyclic segment 32a, 32c of the ion path (e.g. by controlling the number of reflections K ions make between two ion mirrors), i.e. such that one of the effective ion path in the loop Lₘ and the effective ion path outside the loop L₀+L₁ is altered relative to the first mode of operation.

A numerical example of the arrangement depicted in FIG. 8 was modelled, with Lₘ=0.5 m, L₀ and L₁=0.4 m, Lₜ=0.3 m, T₂=0.5 ms and ε₀=1000 eV. A voltage shift of 10V was made to the flight tube 80 between the two spectra. Flight times were calculated for ions with a range of mass to charge ratios from 250-3250 in 150 m/z steps.

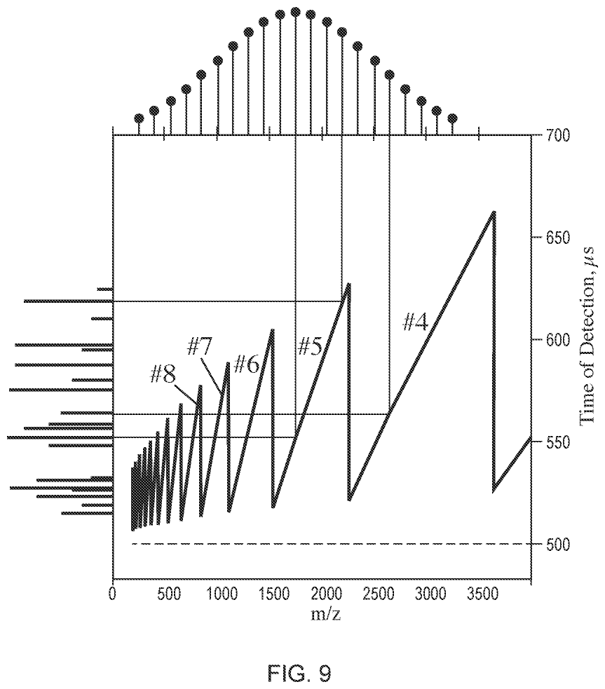

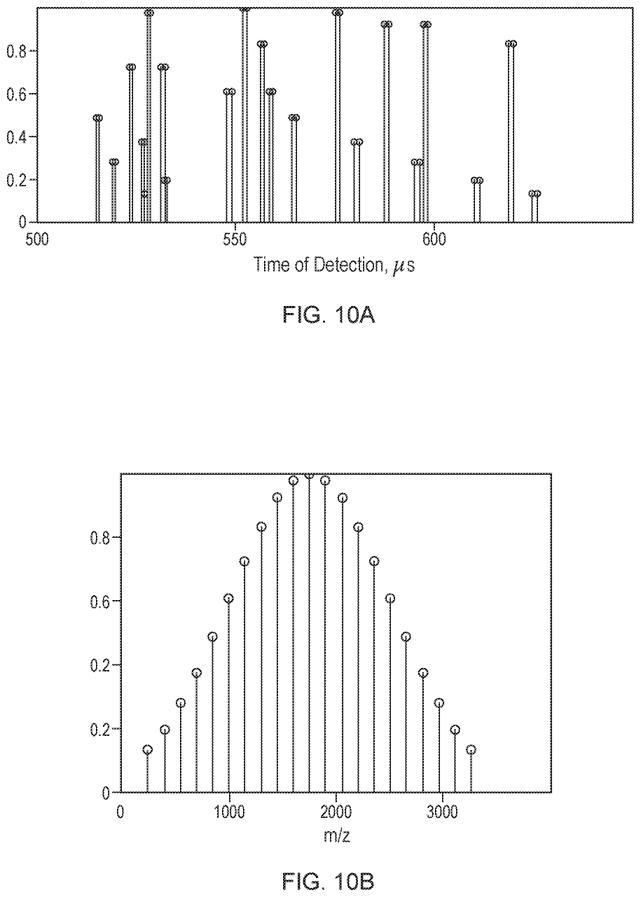

FIG. 9 demonstrates how different m/z ions (top panel) fall into different numbers of reflections, and the consequent convoluted time-of-flight spectrum (left panel).

FIG. 10A shows two overlapping convoluted time-of-flight spectra showing the small shift between peaks generated by a 10V offset applied to the Lₜ region, and FIG. 10B shows the recovered mass spectrum found by measuring the shift between peaks and assigning number of cycles. The information is also reproduced in Table 4.

TABLE 4

| | | | DETEC- | | | |
|---|---|---|---|---|---|---|
| | | DETEC- | TION TIME | | | RECOV- |
| PEAK | MODEL | TION | SHIFTED*, | | | ERED |
| # | M/Z | TIME, μs | μs | N | [N] | M/Z |
| 0 | 250.0 | 526.7950 | 526.8210 | 14.3360 | 14 | 250.0 |
| 1 | 400.0 | 532.1840 | 532.2180 | 11.3960 | 11 | 400.0 |
| 2 | 550.0 | 519.1600 | 519.2000 | 9.7630 | 9 | 550.0 |
| 3 | 700.0 | 526.5310 | 526.5760 | 8.6880 | 8 | 700.0 |
| 4 | 850.0 | 515.0170 | 515.0660 | 7.9120 | 7 | 850.0 |
| 5 | 1000.0 | 558.6140 | 558.6680 | 7.3180 | 7 | 1000.0 |
| 6 | 1150.0 | 523.2180 | 523.2760 | 6.8440 | 6 | 1150.0 |
| 7 | 1300.0 | 556.2960 | 556.3570 | 6.4550 | 6 | 1300.0 |
| 8 | 1450.0 | 587.5140 | 587.5780 | 6.1280 | 6 | 1450.0 |
| 9 | 1600.0 | 527.7120 | 527.7800 | 5.8480 | 5 | 1600.0 |
| 10 | 1750.0 | 551.8940 | 551.9650 | 5.6050 | 5 | 1750.0 |
| 11 | 1900.0 | 575.0610 | 575.1350 | 5.3910 | 5 | 1900.0 |
| 12 | 2050.0 | 597.3290 | 597.4060 | 5.2020 | 5 | 2050.0 |
| 13 | 2200.0 | 618.7970 | 618.8760 | 5.0320 | 5 | 2200.0 |
| 14 | 2350.0 | 531.1470 | 531.2290 | 4.8780 | 4 | 2350.0 |
| 15 | 2500.0 | 547.8370 | 547.9210 | 4.7390 | 4 | 2500.0 |
| 16 | 2650.0 | 564.0320 | 564.1190 | 4.6110 | 4 | 2650.0 |
| 17 | 2800.0 | 579.7760 | 579.8650 | 4.4940 | 4 | 2800.0 |
| 18 | 2950.0 | 595.1030 | 595.1950 | 4.3860 | 4 | 2950.0 |
| 19 | 3100.0 | 610.0450 | 610.1390 | 4.2860 | 4 | 3100.0 |
| 20 | 3250.0 | 624.6300 | 624.7260 | 4.1930 | 4 | 3250.0 |

This example assumes no difficulty in matching peaks before and after the shift, which may be reasonable for small shifts and uncongested spectra. In more complex cases, it may be beneficial to have precise calibrations for both shifted and unshifted spectra, and to assign multiple possible m/z values to each ion peak, and to then match peaks together as described above in respect of the first exemplary disambiguation method.

A mass spectrometer incorporating the analyser design of FIG. 4 was constructed. Analyte ions m/z 524 generated from an electrospray source were isolated by a quadrupole, accumulated and cooled within an extraction ion trap, and ejected into the analyser by a 330V/mm pulsed field, under which they rapidly accelerated to 4 KV flight energy.

Ion dispersion was controlled by a pair of lenses and the ions' direction was set by the first prism deflector 38 so that ions passed through to the second prism deflector 36 via a reflection from an ion mirror 35. The second prism deflector 36 was set to −160V, to admit ions to the analyser. After −200 μs this prism deflector was switched to +280V trapping mode, and held there for 800 μs, sufficient for the ions to make a second drift pass. The prism 37 was then switched back to −160V transmission mode, and the trapped ions were extracted to an electron multiplier detector 33.

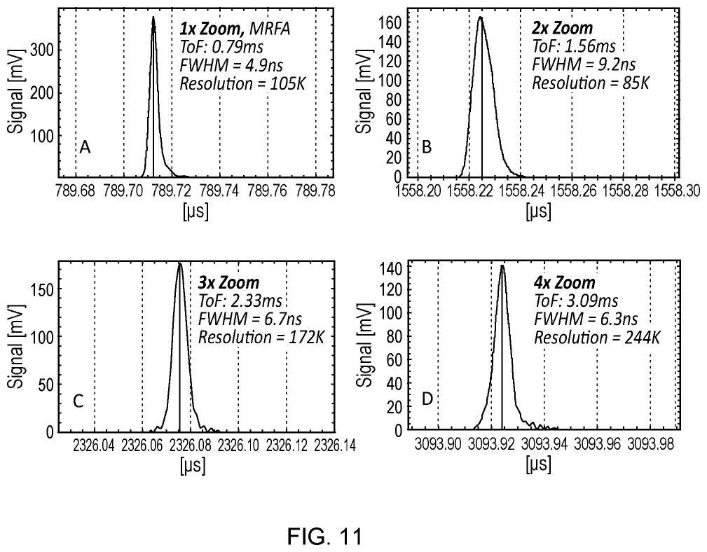

FIG. 11 shows the m/z 524 peaks acquired when the instrument was operated in single pass mode and zoom mode. Far higher resolution was observed in 3× zoom mode without great loss of signal, although higher numbers of drift passes were observed to more substantially reduce transmission.

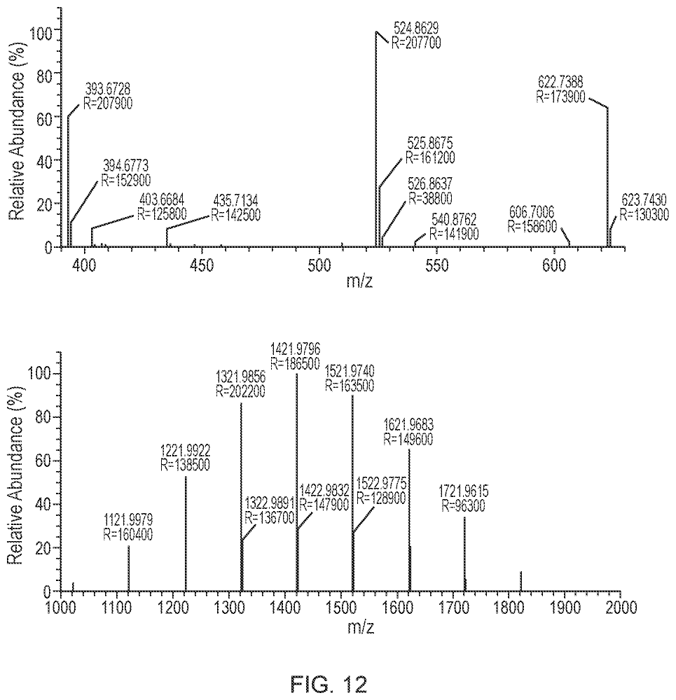

FIG. 12 shows zoom mode mass spectra of infused of Pierce Flexmix calibration solution, a common calibration mixture containing MRFA and Ultramark. In this example, the ion mass ranges delivered to the ToF analyser were first isolated by a resolving quadrupole to remove ambiguous peaks. An approximately 1.6×m/z range was observed from first mass 390.

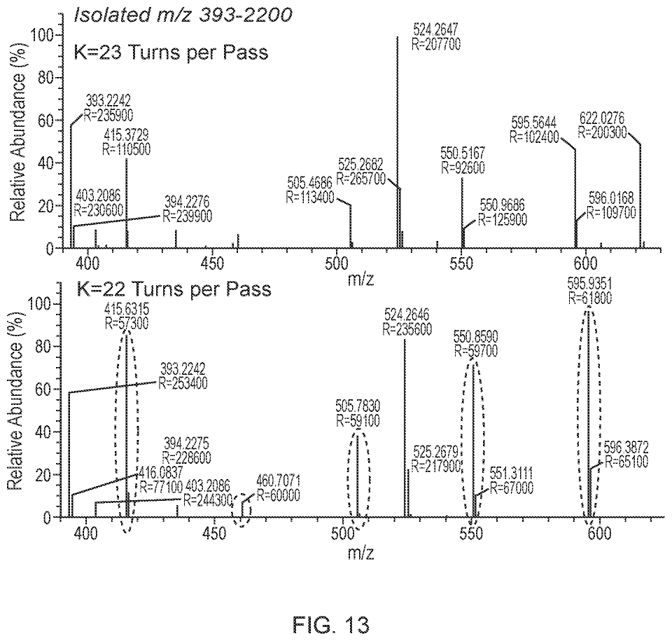

FIG. 13 shows data from a test of the disambiguation method in accordance with the first exemplary embodiment. Flexmix ions were injected into the trap at a much wider m/z isolation window 390-2000 than the unambiguous m/z window 390-625, so that high m/z ultramark ions with −1 drift pass appeared in the mass spectrum. The number of oscillations K per drift pass was then reduced by one, and the mass calibration coefficients recalculated. The high m/z ultramark peaks were observed to have shifted in m/z by −620 ppm, easily allowing their identification.

A similar experiment in accordance with the second exemplary embodiment was performed by varying the ion injector's pulsed extraction field from 330 to 240 V/mm, which caused the high m/z ions to shift by −40 ppm.

It will be appreciated from the above that embodiments provide a method of operating an analytical instrument, such as a time-of-flight mass spectrometer, that comprises an analyser configured to determine flight times of ions along a path which comprises a cyclic segment and a non-cyclic segment. The cyclic segment is configured such that at least some ions make more than one loop in it, and the non-cycling segment is configured such that all ions make only one pass along it. At least one of the cyclic and non-cyclic segments is controlled, e.g., with at least one electrode with a switchable voltage which, when switched, modifies the time-of-flight of an ion in this segment.

The method may comprise determining a first set of times-of-flight of ions upon completion of the cyclic and non-cyclic segments, changing a voltage on at least one of the control electrodes, and then determining a second set of times-of-flight of ions upon completion of the cyclic and non-cyclic segments. The method may comprise determining a number of loops in the cyclic segment made by ions of interest based on time-of-flight differences between the first and the second sets of times-of-flight. The method may comprise then determining a mass-to-charge ratio of at least one ion based on the full flight path that comprises the determined number of loops in the cyclic part.

The cyclic or non-cyclic segment may be controlled by a voltage which modifies, when applied, an ion velocity in at least a section of the path which, in turn, modifies the time-of-flight in the said cyclic or non-cyclic segment. The cyclic segment may be controlled by a voltage which modifies an ion flight length in this segment. The ions may make more than one oscillation within a single loop in the cyclic segment, and the number of such oscillations may be controlled by application of a control voltage.

The relative difference of the times-of-flight in the first set and the second set may substantially depend on the number of loops of an ion trajectory in the cyclic segment, and the number of said loops may be estimated from the said difference for at least one ion. The mass-to-charge ratios may be estimated for a set of candidate number of loops, and the true number of loops may be determined by comparison of the mass-to-charge ratios estimated on the first and the second sets of the times-of-flight.

Although the present invention has been described with reference to various embodiments, it will be understood that various changes may be made without departing from the scope of the invention as set out in the accompanying claims.

1. A method of operating an analytical instrument that comprises an ion analyser configured to analyse ions by determining drift times of ions along an ion path, the ion path comprising at least a first segment, and a cyclic segment, wherein the ion path is configured such that ions make a single pass of the first segment and make one or more passes of the cyclic segment; the method comprising:
operating the analyser in a first mode of operation, wherein in the first mode of operation (i) a first electric potential is provided along the first segment of the ion path, (ii) a second electric potential is provided along the cyclic segment of the ion path, (iii) the first segment of the ion path has a first path length, and (iv) the cyclic segment of the ion path has a second path length, and analysing ions by determining drift times of ions along the ion path so as to obtain a first set of ion data;
operating the analyser in a second mode of operation by altering at least one of (i) the first electric potential, (ii) the second electric potential, (iii) the first path length, or (iv) the second path length, and analysing ions by determining drift times of ions along the ion path so as to obtain a second set of ion data;
comparing the first set of ion data to the second set of ion data, and identifying a first ion peak in the first set of ion data that corresponds to a second ion peak in the second set of ion data;
determining the number N of passes of the cyclic segment of the ion path taken by ions associated with the corresponding first and second ion peaks; and
using the determined number of passes N to determine a value of a physicochemical property of the ions associated with the corresponding first and second ion peaks.

2. The method of claim 1, wherein the ion analyser is a time-of-flight (ToF) mass analyser, and wherein the physicochemical property is mass to charge ratio (m/z).

3. The method of claim 2, wherein the time-of-flight mass analyser is a multi-reflection time-of-flight (MR-ToF) mass analyser comprising:
two ion mirrors spaced apart and opposing each other in a first direction X, each mirror elongated generally along a drift direction Y between a first end and a second end, the drift direction Y being orthogonal to the first direction X;
an ion injector for injecting ions into a space between the ion mirrors, the ion injector located in proximity with the first end of the ion mirrors; and
a detector for detecting ions after they have completed a plurality of reflections between the ion mirrors, the detector located in proximity with the first end of the ion mirrors.

4. The method of claim 3, wherein the analyser is configured to analyse ions by:
(i) injecting ions from the ion injector into the space between the ion mirrors, wherein the ions complete a first cycle in which the ions follow a zigzag ion path having plural K reflections between the ion mirrors in the direction X whilst: (a) drifting along the drift direction Y towards the second end of the ion mirrors, (b) reversing drift direction velocity in proximity with the second end of the ion mirrors, and (c) drifting back along the drift direction Y towards the first end of the ion mirrors;
(ii) reversing the drift direction velocity of the ions in proximity with the first end of the ion mirrors such that the ions are caused to complete a further cycle in which the ions follow a zigzag ion path having plural K reflections between the ion mirrors in the direction X whilst:
(a) drifting along the drift direction Y towards the second end of the ion mirrors, (b) reversing drift direction velocity in proximity with the second end of the ion mirrors, and (c) drifting back along the drift direction Y towards the first end of the ion mirrors;
(iii) repeating step (ii) one or more times; and then
(iv) causing the ions to travel to the detector for detection.

5. The method of claim 4, wherein the multi-reflection time-of-flight (MR-ToF) mass analyser further comprises:
a deflector located in proximity with the first end of the ion mirrors; and
wherein the analyser is configured to analyse ions by:
(i) injecting ions from the ion injector into the space between the ion mirrors, wherein the ions complete a first cycle in which the ions follow a zigzag ion path having plural K reflections between the ion mirrors in the direction X whilst: (a) drifting along the drift direction Y from the deflector towards the second end of the ion mirrors, (b) reversing drift direction velocity in proximity with the second end of the ion mirrors, and (c) drifting back along the drift direction Y to the deflector;
(ii) using the deflector to reverse the drift direction velocity of the ions such that the ions are caused to complete a further cycle in which the ions follow a zigzag ion path having plural K reflections between the ion mirrors in the direction X whilst: (a) drifting along the drift direction Y from the deflector towards the second end of the ion mirrors, (b) reversing drift direction velocity in proximity with the second end of the ion mirrors, and (c) drifting back along the drift direction Y to the deflector;
(iii) repeating step (ii) one or more times; and then
(iv) causing the ions to travel from the deflector to the detector for detection.

6. The method of claim 4, wherein the method comprises altering the second path length in the second mode of operation by altering the number K of reflections that ions make between the ion mirrors when following the zigzag ion path.

7. The method of claim 6, wherein the number K of reflections that ions make between the ion mirrors when following the zigzag ion path is altered by altering a voltage applied to the deflector.

8. The method of claim 5, wherein the ion mirrors are a non-constant distance from each other in the X direction along at least a portion of their lengths in the drift direction Y, wherein the drift direction velocity of ions towards the second end of the ion mirrors is opposed by an electric field resulting from the non-constant distance of the two mirrors from each other, and wherein the electric field causes the ions to reverse their drift direction velocity in proximity with the second end of the ion mirrors and drift back along the drift direction towards the deflector.

9. The method of claim 5, wherein the deflector is a first deflector, and the analyser comprises a second deflector located in proximity with the second end of the ion mirrors, wherein the second deflector is configured to cause the ions to reverse their drift direction velocity in proximity with the second end of the ion mirrors and drift back along the drift direction towards the deflector.

10. The method of claim 1, wherein the analyser is an ion mobility analyser, and wherein the physicochemical property is ion mobility.

11. The method of claim 1, wherein the method comprises altering the first electric potential in the second mode of operation.

12. The method of claim 11, wherein the instrument further comprises a flight tube arranged along at least part of the first segment of the ion path, and wherein the method comprises altering the first electric potential in the second mode of operation by altering a voltage applied to the flight tube.

13. The method of claim 11, wherein the ion analyser comprises an ion injector configured to accelerate ions along the ion path, and wherein the method comprises altering the first electric potential in the second mode of operation by altering an acceleration field provided by the ion injector for accelerating ions along the ion path.

14. The method of claim 1, wherein determining the number N of passes of the cyclic segment of the ion path taken by ions associated with the corresponding first and second ion peaks comprises:
measuring a drift time difference between first and second ion peaks; and
using the measured drift time difference to estimate the number N of passes of the cyclic segment of the ion path taken by ions associated with the corresponding first and second ion peaks.

15. A non-transitory computer readable storage medium storing computer software code which when executed on a processor performs the method of claim 1.

16. A control system for an analytical instrument, the control system configured to cause the analytical instrument to perform the method of claim 1.

17. An analytical instrument, such as a mass and/or ion mobility spectrometer, comprising:
an ion analyser configured to analyse ions by determining drift times of ions along an ion path, the ion path comprising at least a first segment, and a cyclic segment, wherein the ion path is configured such that ions make a single pass of the first segment and make one or more passes of the cyclic segment; and
a control system configured to:
operate the analyser in a first mode of operation and analyse ions by determining drift times of ions along the ion path so as to obtain a first set of ion data, wherein in the first mode of operation (i) a first electric potential is provided along the first segment of the ion path, (ii) a second electric potential is provided along the cyclic segment of the ion path, (iii) the first segment of the ion path has a first path length, and (iv) the cyclic segment of the ion path has a second path length;
operate the analyser in a second mode of operation by altering at least one of (i) the first electric potential, (ii) the second electric potential, (iii) the first path length, or (iv) the second path length, and analyse ions by determining drift times of ions along the ion path so as to obtain a second set of ion data;
compare the first set of ion data to the second set of ion data, and identify a first ion peak in the first set of ion data that corresponds to a second ion peak in the second set of ion data;
determine the number N of passes of the cyclic segment of the ion path taken by ions associated with the corresponding first and second ion peaks; and
use the determined number of passes N to determine a value of a physicochemical property of the ions associated with the corresponding first and second ion peaks.

18. The analytical instrument of claim 17, wherein
the ion analyser is a time-of-flight (ToF) mass analyser, and the physicochemical property is mass to charge ratio (m/z); or
the analyser is an ion mobility analyser, and the physicochemical property is ion mobility.

19. The analytical instrument of claim 17, wherein the analyser is a multi-reflection time-of-flight (MR-ToF) mass analyser comprising:
two ion mirrors spaced apart and opposing each other in a first direction X, each mirror elongated generally along a drift direction Y between a first end and a second end, the drift direction Y being orthogonal to the first direction X;
an ion injector for injecting ions into a space between the ion mirrors, the ion injector located in proximity with the first end of the ion mirrors; and
a detector for detecting ions after they have completed a plurality of reflections between the ion mirrors, the detector located in proximity with the first end of the ion mirrors;
wherein the analyser is configured to analyse ions by:
(i) injecting ions from the ion injector into the space between the ion mirrors, wherein the ions complete a first cycle in which the ions follow a zigzag ion path having plural K reflections between the ion mirrors in the direction X whilst: (a) drifting along the drift direction Y towards the second end of the ion mirrors, (b) reversing drift direction velocity in proximity with the second end of the ion mirrors, and (c) drifting back along the drift direction Y towards the first end of the ion mirrors;
(ii) reversing the drift direction velocity of the ions in proximity with the first end of the ion mirrors such that the ions are caused to complete a further cycle in which the ions follow a zigzag ion path having plural K reflections between the ion mirrors in the direction X whilst: (a) drifting along the drift direction Y towards the second end of the ion mirrors, (b) reversing drift direction velocity in proximity with the second end of the ion mirrors, and (c) drifting back along the drift direction Y towards the first end of the ion mirrors;
(iii) repeating step (ii) one or more times; and then
(iv) causing the ions to travel to the detector for detection.

20. The instrument of claim 19, further comprising a deflector located in proximity with the first end of the ion mirrors and wherein reversing the drift direction velocity of the ions includes using the deflector to reverse the drift direction velocity of the ions.
